(19) United States
(12) Patent Application Publication
(10) Pub. No.: US 2023/0230036 A1
(43) Pub. Date: Jul. 20, 2023

(54) SYSTEM FOR PREPARING PROJECT SPECIFICATIONS AND REPORTING USE OF PRODUCT TYPES ON A GEOGRAPHIC BASIS

(71) Applicant: Connor Christian, Omaha, NE (US)

(72) Inventor: Connor Christian, Omaha, NE (US)

(21) Appl. No.: 18/099,114

(22) Filed: Jan. 19, 2023

Related U.S. Application Data
(60) Provisional application No. 63/301,034, filed on Jan. 19, 2022.

(51) Int. Cl. G06Q 10/10; G06F 16/957

(52) U.S. Cl. CPC G06Q 10/103; G06F 16/9577

(57) ABSTRACT

A system for preparing PSB that classifies specification sections by specification type is described. The system prepares the PSB from an MSB with the specification sections classified according to the following specification types within each specification: specification section number, specification title, section part, specifications, and styles. The system also provides efficient preparation and utilization of a designer's preferred styles.

A system for displaying product type information on a geographic basis for use by manufacturers is also described. This allows manufacturers to understand where their products are utilized on a geographic basis, as well as if those products are designer preferred products (base) or alternate preferred products (alternate).

This application claims the benefit of U.S. Provisional Application No. 63/301,034 entitled “SYSTEM FOR PREPARING PROJECT SPECIFICATIONS AND REPORTING USE OF PRODUCT TYPES ON A GEOGRAPHIC BASIS” filed Jan. 19, 2022, which is incorporated by reference in its entirety.

### BACKGROUND

Successful project management of construction projects (e.g. building homes, roads, facilities, and the like) typically employs the use of project specification books (PSB). PSB contain a collection of specification sections, where each specification section covers a discrete component of the project. For each discrete component of the project the specification section assigns the component a specification section number and specification section title to identify the component. The specification section further includes one or more section parts and one or more specifications that accompany the section part. Categorization of information in this manner provides uniformity across specification sections and the PSB as a whole.

The PSB functions as a structured guide to the construction process by systematically outlining the scope of work, materials, performance requirements, and standards for performance. Therefore, efficiently developing a PSB aids in effectively organizing and completing a project.

Designers (e.g. architects, engineers, and the like) typically prepare PSB. To create a PSB, designers may work from a master specification book (MSB), which is a collection of specification sections that are non-specific to any single project, where designers select those relevant specification sections based on the designers knowledge and expertise. This conventional method may include the use of a structured databased, where the MSB is organized according to specification section numbers. Relatedly, another conventional method of PSB creation includes copying a previously used PSB (i.e. copying the text documents using a conventional word processing program) and modifying it as necessary, again based on the knowledge and expertise of the designer.

These conventional methods do not allow for categorization of data based on the content of the specification section, such as the specifications including, products types, design preferences, and manufacturers, which is time consuming and inefficient in the preparation of the PSB. Moreover, these conventional methods do not include any classification of projects based on geography. These conventional methods are time consuming as a designer may be required to filter through multiple specification sections when building a PSB or MSB to find the correct specification section applicable to a particular geography, or the designer may be required to create details for the specification section, such as product type, for a particular geography. These conventional methods are inefficient as they do not provide a mechanism to search and filter specification sections based on any parameters other than the specification section number.

Further, because this conventional method focuses on categorization based only on specification section number, useful information is not derived from the specification sections, such as frequency of specification section use, products type use per geography, or standards, for future use by designers or manufacturers. In particular, manufacturers of products do not have a comprehensive mechanism for gaining knowledge about where their products are used (popularity by geography), nor how their products are used (whether a particular product is a designer preferred product or an alternate preferred product). Without this information, manufacturers are unable to make informed decisions regarding targeted marketing of their products, nor are they able to have discussions with designers about their products, including the potential for particular products to be preferred designer products.

It is therefore desirable to have a system for preparing PSB that classifies specification section information on a basis other than solely utilizing the specification section number, such as frequency of specification section use, products types per geography, and standards (i.e. comprehensive classification of information). It is further desirable to have a system for building PSB based on this comprehensive classification of information. Finally, it is desirable for the system to provide product type information on a geographic basis, such as for use by manufacturers.

### SUMMARY

In aspects of the invention a method of creating a project specification book (PSB) via a computer network, the method including receiving a PSB creation input at a first computer system, the PSB creation input having been transmitted via the computer network from a second computer system, the PSB creation input including a request to begin PSB creation; based upon the PSB creation input, transmitting via the computer network from the first computer system to the second computer system, a PSB creation output, the PSB creation output configured for causing a project information entry to be displayed by the second computer system, wherein providing the project information entry includes causing a webpage having project information entries to be displayed via a display of the second computer system, the webpage being associated with a website of a service provider; receiving a project information input at the first computer system, the project information input having been transmitted via the computer network from the second computer system, the project information input including project information; processing the project information input by the first computer system, the processing including creating a project text file in a project index of a service provider database, where the first computer system assigns properties of the project index and the information of the project information input to the text file of the project index; based upon the processing, transmitting via the computer network from the first computer system to the second computer system a project page output for causing project information to be displayed by the second computer system, wherein providing the project information includes causing a webpage having project information to be displayed via the display of the second computer system, the webpage being associated with the website of the service provider; receiving a project page input at the first computer system from the second computer system transmitted via the network, the project page input including a selected PSB and a selected PSB style; processing the project page input by the first computer system, the processing including creating a text file in a PSB index of the service provider database, where the first computer system assigns properties of the PSB index and the information of the project page input to the text file of the PSB index; based upon the processing, transmitting via the computer network from the first computer system to the second computer system a PSB page output for causing PSB information to be displayed by the second computer system, wherein providing the PSB information includes causing a webpage having PSB information to be displayed via a display of the second computer system, the webpage being associated with a website of the service provider; receiving an add/remove specification section input at the first computer system from the second computer system transmitted via the network, the add/remove specification section input including a request for the first computer system to lookup via inverted index search master specification books of a master specification book (MSB) index of the service provider database having a company id associated with a user of the second computer system; based upon the add/remove specification section input, transmitting via the computer network from the first computer system to the second computer system an MSB output for causing an MSB selection to be displayed by the second computer system, wherein providing the MSB selection includes causing a webpage having MSB names of the looked up master specification books to be displayed via a display of the second computer system, the webpage being associated with a website of the service provider; receiving an MSB selection input at the first computer system from the second computer system transmitted via the network, the MSB selection input including a selected MSB name and configured for causing the first computer system to search via inverted index search of a published specification index of the service provider database for specification section text files having an MSB id that is associated with the selected MSB name; based upon the processing of the MSB selection input, transmitting via the computer network from the first computer system to the second computer system a specification sections output for causing specification section numbers of the specifications section text files from the looked up specification section text files to be displayed by the second computer system, wherein providing the specification sections includes causing a webpage having specification section numbers to be displayed via a display of the second computer system, the webpage being associated with a website of the service provider; receiving a populate PSB input at the first computer system from the second computer system transmitted via the network, the populate PSB selection input including selected specification section numbers and configured for causing the first computer system to process the selected specification sections, wherein the processing includes copying text files of the selected specification sections from a published specification section index of the service provider database having the MSB id and a published specification section id of the selected specification sections to a working specification sections index of the service provider database and assigning the working specification sections index properties; and copying text files of specifications associated with the selected specification sections from a published specification index having the published specification section id to a working specifications index of the service provider database and assigning the working specification index properties; based upon the processing of the populate PSB selection input, transmitting via the computer network from the first computer system to the second computer system a working specification sections output for causing an array of the specification sections of the to be displayed by the second computer system, wherein providing the specification sections array includes causing a webpage having specification section numbers, description, modification date, and user to be displayed via a display of the second computer system, the webpage being associated with a website of the service provider; receiving a specification section edit request input at the first computer system from the second computer system transmitted via the network, the specification section edit request input including a selected specification section and configured for causing the first computer system to process the selected specification section for editing, wherein the processing includes identifying specifications associated with the selected specification section via inverted index search using the specification section id of the specification text files of the working specification index; based upon the processing of the specification section edit request, transmitting via the computer network from the first computer system to the second computer system a specification section edit output for causing the specifications of the selected specification section to be displayed by the second computer system, wherein providing the specifications includes causing a webpage having the specification sections to be displayed via a display of the second computer system, the webpage being associated with a website of the service provider; receiving a specification edit input at the first computer system from the second computer system transmitted via the network, the specification section edit input including edits to the specifications and configured for causing the first computer system to process the specification edits, wherein the processing includes saving the specification edits in the working specifications index; based upon the processing of the specification section edit input, receiving a publish request input at the first computer system from the second computer system transmitted via the network, the publish request input configured for causing the first computer system to copy all edited text files from the working specification sections index and working specifications index as text files to the published specification sections index and published specifications index and assigning the associated properties to each newly copied text file of the published specifications section and the published specifications to create the PSB.

In aspects of the invention, a method of determining product use in a geographic area via a computer network, the method including receiving a product search initiation input at a first computer system, the product search initiation input having been transmitted via the computer network from a third computer system being associated with a manufacturer, the product search initiation input including a request to begin a product search; based upon the product search initiation input, transmitting via the computer network from the first computer system to the second computer system a product search output for causing a product search entry to be displayed by the second computer system, wherein providing the product search entry causing a webpage having the product search entries of a product name and a product geography to be displayed via a display of the second computer system, the webpage being associated with a website of a service provider; based upon the product search entry, receiving a product search input at a first computer system, the product search input having been transmitted via the computer network from a third computer system, the product search input including information entered for a product and a geography of interest and configured for causing the first computer system to process the product search input; processing the product search input by the first computer system, the processing including searching a reporting index of a service provider database via inverted index search to identify text files having the product and geography properties equal to the product search input and the manufacturer's name; transmitting via the computer network from the first computer system to the third computer system a product results output for causing product use information in the geography to be displayed by the third computer system, wherein providing the product results causing a webpage having the product search results to be displayed via a display of the second computer system, the webpage being associated with a website of the service provider.

In aspects, a method of determining standard use in a geographic area via a computer network, the method including receiving a standard search initiation input at a first computer system, the standard search initiation input having been transmitted via the computer network from a third computer system being associated with a manufacturer, the standard search initiation input including a request to begin a standard search; based upon the standard search initiation input, transmitting via the computer network from the first computer system to the second computer system a standard search output for causing a standard search entry to be displayed by the second computer system, wherein providing the standard search entry causing a webpage having the standard search entries of a standard name and a geography to be displayed via a display of the second computer system, the webpage being associated with a website of the service provider; based upon the standard search entry, receiving a standard search input at a first computer system, the standard search input having been transmitted via the computer network from a third computer system, the standard search input including information entered for a standard and a geography of interest and configured for causing the first computer system to process the standard search input; processing the standard search input by the first computer system, the processing including searching a reporting index of a service provider database via inverted index search to identify text files having the standard and geography properties equal to the standard search input; transmitting via the computer network from the first computer system to the third computer system a standard results output for causing standard use information in the geography to be displayed by the third computer system, wherein providing the standard results causing a webpage having the standard search results to be displayed via a display of the second computer system, the webpage being associated with a website of the service provider.

In aspects, a method for identifying changes to a project specification section via a computer network, the method including receiving a comparison input at a first computer system, the comparison input having been transmitted via the computer network from a second computer system, the comparison input including a request to process a comparison of a preselected project specification section to an associated master specification section, the first computer system being associated with a service provider, the second computer system being associated with a designer; based upon the comparison input, processing the comparison of the preselected project specification section to the associated master specification section, the comparison being processed by the first computer system, where the processing includes the first computer system searching a published specifications index of a service provider database to identify published specification ids of a published specification index that match ms parent spec ids of specifications of the preselected specification section; and upon identification of matching published specification ids and ms parent spec ids comparing the content of the text files associated with the ms parent spec ids and published specification ids to generate a comparison of the preselected specification index to the published specification section; transmitting a comparison output from the first computer system to the second computer system via the computer network, the comparison output configured for the comparison of the preselected specification index to the published specification section to be provided to the second computer system, wherein providing the comparison includes causing the webpage having the comparison to be displayed via the display of the second computer system.

### FIGURES

FIG. 1 is a block diagram 100 representing a system for preparing PSB and reporting use of product types on a geographic basis.

FIG. 2a is a class diagram of a service provider database of the system for preparing PSB and reporting use of product types on a geographic basis. FIG. 2a continues horizontally onto a second page.

FIG. 2b is a flow chart representing a method for classifying specifications.

FIG. 2c is a flow chart representing a method for classifying products.

FIG. 2d is a consolidated class diagram of a service provider database of the system for preparing PSB and reporting use of product types on a geographic basis. FIG. 2d continues horizontally onto a second page.

FIG. 2e is a second class diagram of a service provider database of the system for preparing PSB and reporting use of product types on a geographic basis. FIG. 2e continues horizontally onto a second page.

FIG. 3a is a flow chart representing a method for assessing use of products on a geographic basis using the system.

FIG. 3b is a mock up display of the results of the method for assessing use of a product on a geographic basis.

FIG. 3c is a mock up display of a designer's dashboard that is unfiltered.

FIG. 3d is a mock up display of a designer's dashboard that is filtered by project name.

FIG. 3e is a flow chart presenting a method 310 of determining standards used in a geographic area.

FIG. 3f is a mock up display of a manufacturer's dashboard utilizing a standards search.

FIG. 4a is a flow chart representing a method for creating a PSB in connection with a project.

FIG. 4b. is a mockup of a specification section output of the method 400.

FIG. 4c is a mock of a specification section edit output of the method 400.

FIG. 5a is a flow chart representing a method for comparing an MSB to a PSB in connection with a project.

FIG. 5b is a mockup of a the comparison output of the method 500 showing a comparison of an MSB to a PSB.

### DETAILED DESCRIPTION

As used in this application, the following terms have the associated defined meaning:

“Master specification book” or “MSB” means a collection of specification sections which are used as a template to apply to future projects. MSBs are not used directly on projects, rather MSBs are used as a starting point for projects. Specification sections of MSBs are copied to create a PSB for a particular project. MSBs are editable by a user with the master specification writer user role, where these revisions will not retroactively apply to previous PSBs, only the subsequent PSBs.

“Project specification book” or “PSB” means a collection of specification sections which are used as a starting point for projects. PSBs are often edited during the course of a project as it progresses. PSBs are created by copying an MSB and selecting relevant specification sections. PSBs may also be created by copying an existing PSB and selecting relevant specification sections.

“Project” means the construction project that the PSB is directed toward. For example, projects may range from infrastructure to transportation, such as buildings (including commercial and residential), roads, highways, bridges, and the like. Projects may include different modules (i.e. more than one building, structure, road, bridge or the like), where a “module of a project” refers to a single module. Each project has at least one module.

“Specification section” means the discrete file containing the specification section number, specification section title, section part, and specifications.

“Specification section number” means the number assigned to identify a particular specification section.

“Specification section title” means the title of the specification section descriptive of the product to which the specification section pertains. Only a single specification section title is permitted per specification section.

Specification sub-title” means the title of a sub-section of the specification section title. Only a single specification section sub-title is permitted per specification section.

“Section part” means an identification of a part of the specification section having instructional specifications, where each specification section has at least one section part. A section part may contain section headers. For example, a three part specification contains three section parts including specifications pertaining to (1) general information, (2) product information, and (3) execution. Or for example, a pay item specification contains one section part including specifications pertaining to production information.

“Section header” means a specification that designates the beginning of a new specification in the section part. For example, in a three part specification in the general information section part, there may be section headers for related documents, summary, pre-installation meetings, action submittals, informational submittals, quality assurance, delivery/storage/handling, and the like. Or for example, in a pay item specification in the product information section part, there may be section headers for performance requirements, products, fabrication, and the like.

“Specification” means the description of the parameters of discrete items of the project and include the following: general specification, product type, product, design preference, manufacture, instruction, and standard.

“General Specification” means a specification that communicates a direction or fact about products or processes related to the products.

“Product Type” means a specification that identifies the article of manufacture type that will be used on the project, where the product type is the common name for a product that is not specific to a manufacturer. For example, if the product is boutique facial tissue, the product type would be tissue paper. Other examples of product types include compose metal decks, concrete patio, or kitchen counter

“Product” means the particular article of manufacture that the specification is directed towards. For example, products may range from Type W2 Formlok (corresponding to a composite metal deck product type), to Formula One, Guard W. (corresponding to a concrete finish product type), to Everform™ Solid Surface (corresponding to a kitchen counter product type).

“Design Preference” means a specification that designates the priority of one manufacturer over another. The projection specification writer defines the priority of one manufacturer over another.

“Manufacturer” means a specification that designates a particular manufacturer for a product.

“Standard” means a specification that references an industry standard that is separate from the PSB.

“Instruction” means a specification that is an instruction from the master specification writer to project specification writers.

“Style” means an instruction for stylization such as a table, divider symbol (e.g. characters), or colors.

“Designer” means an individual or entity that prepares PSB and MSB for projects.

“Master Specification Writer” means an individual that prepares the MSB. Master specification writers are associated with the designer.

“Project Specification Writer” means an individual that prepares the PSB. Project specification writers are associated with the designer.

“Manufacturers” means an individual or entity that creates the product.

“Stored” or “storing” means the processing element of the computing device directing the storage of a value or information in the memory using non-transient software code and data stored in the memory of the computing device to carry out the storing of the value or information.

“Processing” means the processing element of a computing device using computer readable non-transient software code and data stored in the memory of the computing device to carry out a processing function.

“Transmitting” means the processing element of a computing device using computer readable non-transient software code and data stored in the memory of the computing device to carry out transmitting an output.

“Receiving” means the processing element of a computing device using computer readable non-transient software code and data stored in the memory of the computing device to carry out receiving an input.

“Displaying” means the processing element of a computing device using computer readable non-transient software code and data stored in the memory of the computing device to direct display of an output by a display of the computing device when a non-transitory computer-readable medium having computer executable instructions is installed on a computing device.

“Validating” or “validate” means the processing element of a computing device using computer readable non-transient software code and data stored in the memory of the computing device to direct authentication of account login information associated with a registered account.

A system for preparing PSB that classifies specification sections by specification type is described. The system prepares the PSB from an MSB with the specification sections classified according to the following specification types within each specification: specification section number, specification title, section part, specifications, and styles. The system also provides efficient preparation and utilization of a designer's preferred styles.

A system for displaying product type information on a geographic basis for use by manufacturers is also described. This allows manufacturers to understand where their products are utilized on a geographic basis, as well as if those products are designer preferred products (base) or alternate preferred products (alternate). In the system described herein, a service provider provides a computer-based (e.g. online or installed) program (e.g. via a website of the service provider or through software installed on a computer) for efficiently preparing PSB and displaying product types per geographic area in response to user initiated searches. This system allows project specification writers to efficiently build PSB from MSB, and the system allows manufacturers to determine where there products are being used per geographic location.

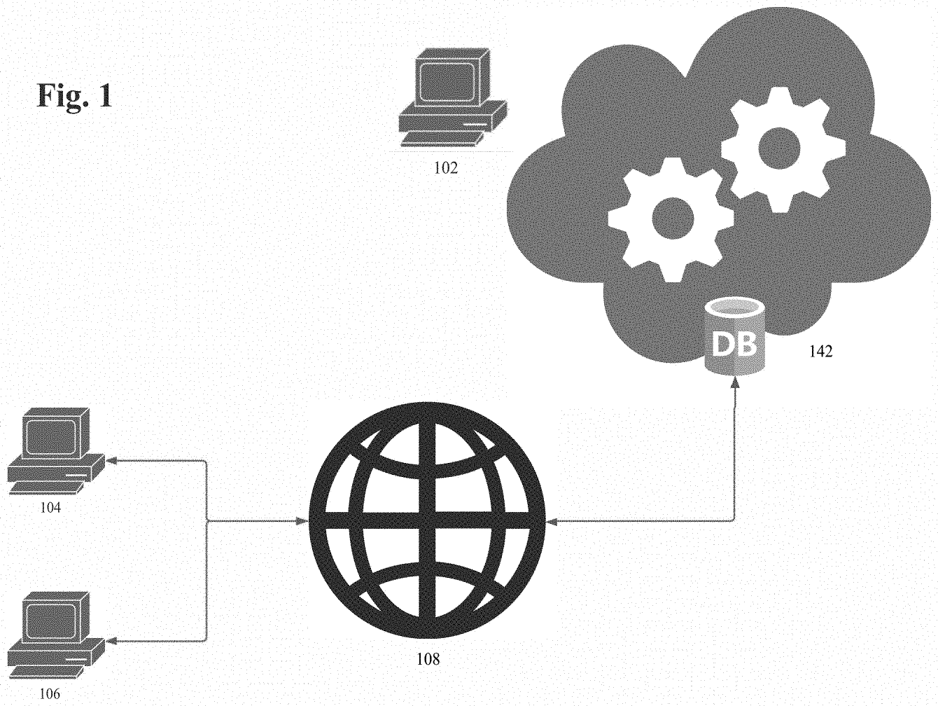

FIG. 1 is a block diagram 100 representing a system for preparing PSB and reporting use of product types on a geographic basis (referred to as product type reporting). The system may include a first computer system 102, a second computer system 104, and a third computer system 106. The preparation of PSB and product type reporting may be provided as computer-based (e.g. online, web-based) services via an Internet site (e.g. website) associated with a provider of the services (e.g. service provider).

A first computer system 102 is associated with the service provider. The first computer system 102 may include one or more computing devices 112 (e.g. servers, nodes, computers). As used herein, the “computing device” may refer to a general purpose device that can be programmed to carry out various sets of arithmetic or logical operations. Further, the computing device may include one or more processing elements 122 (e.g. processors, central processing unit (CPU)) and some form of memory 132 (e.g. data storage device, database), the memory being connected to (e.g. communicatively coupled with) the processing element(s). The computing device may further include one or more user interface devices (e.g. user input devices), such as a keyboard, mouse, display, and/or the like, which are connected to (e.g. communicatively coupled with) the processing element(s). As used herein, the term “server” may refer to software (and suitable computer hardware) which is configured for providing (or helping to provide) a network service. For example, the term “server” may refer to software which is executed on a dedicated computer (e.g. hosted by a networked computer) or executed on a computer in a shared hosting environment. Further, the term “server” may refer to the dedicated computer itself. Further, the term “server” may refer to a computer program which may execute to service the requests of other computer programs. When the first computer system 102 includes multiple computing devices, the multiple computing devices of the first computer system may be connected to (e.g. communicatively coupled with) each other.

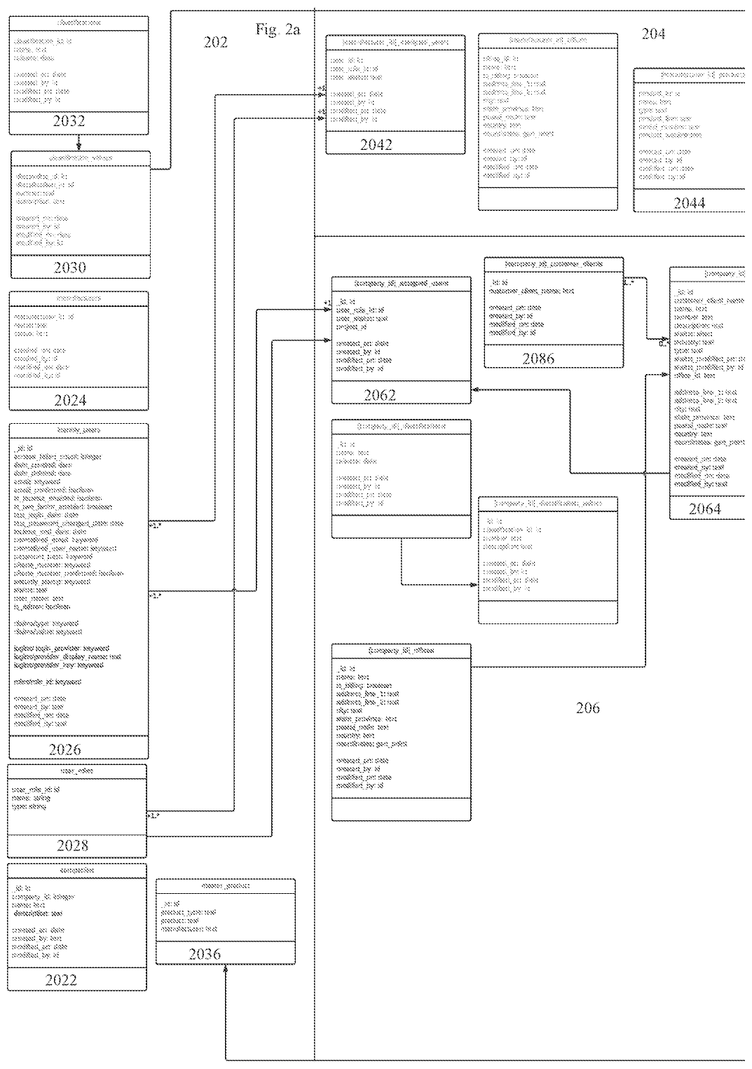

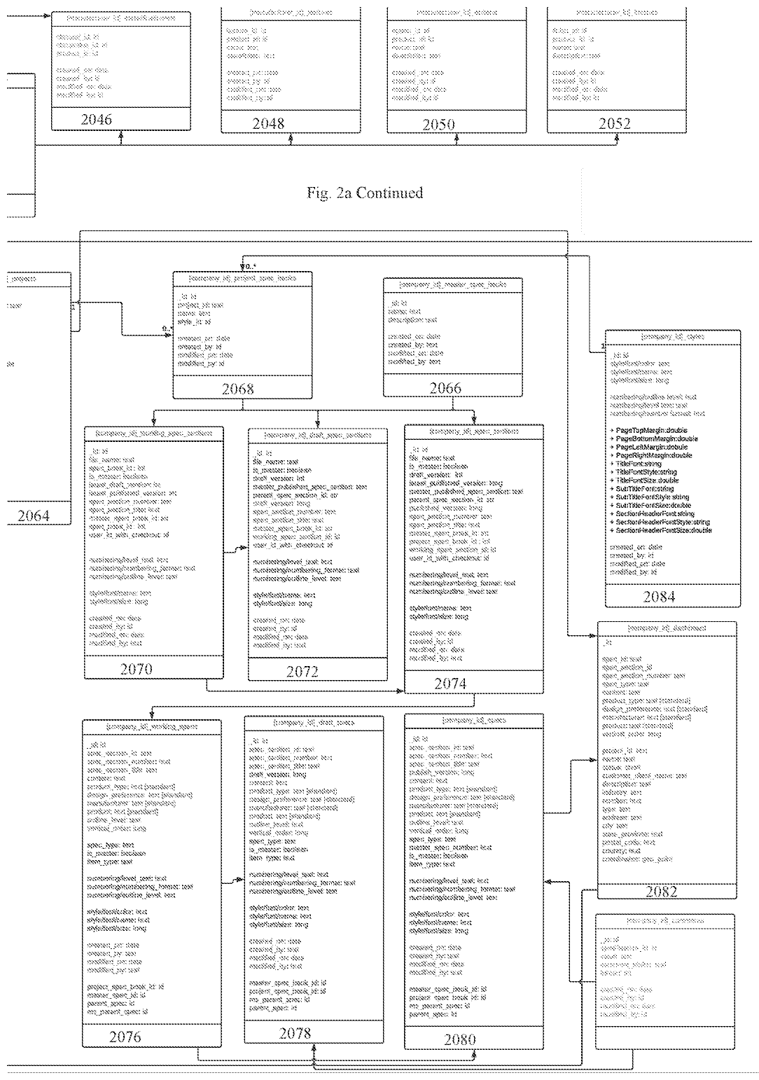

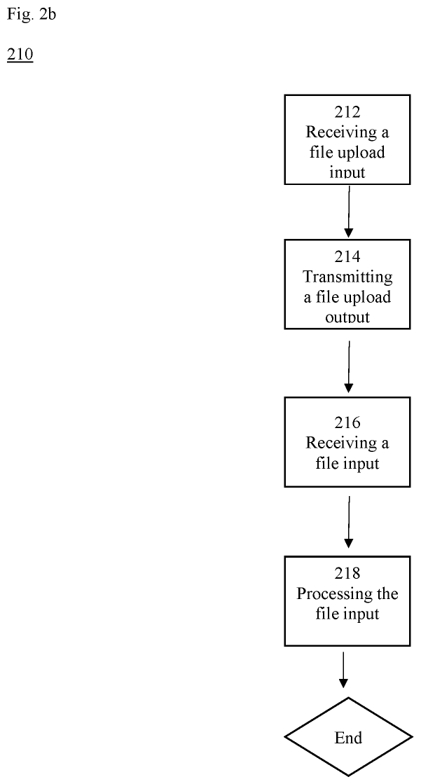

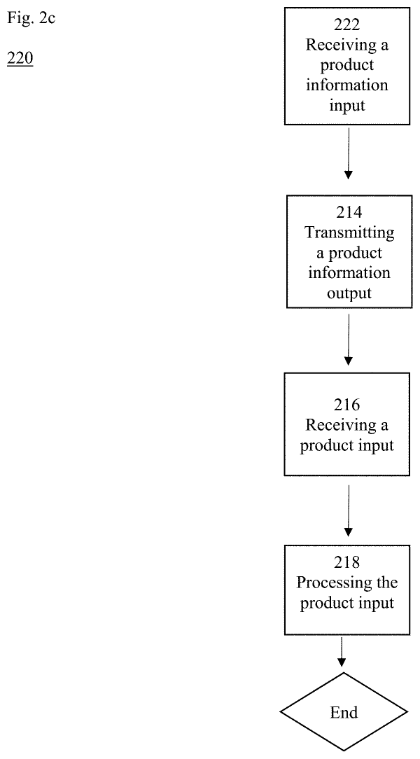

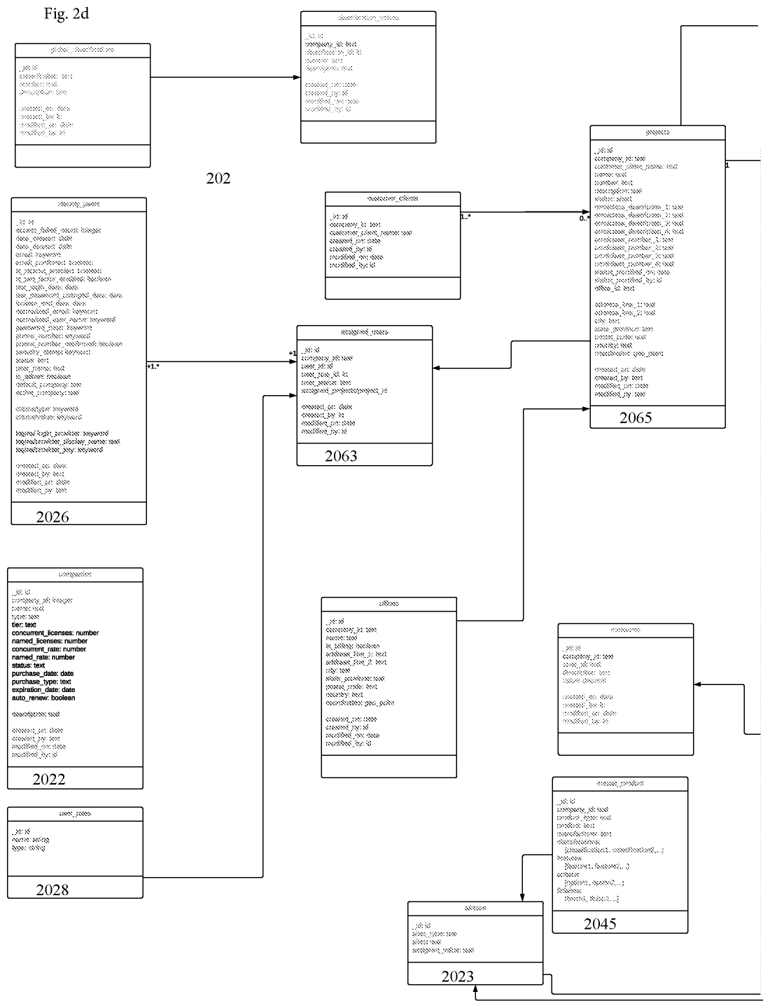

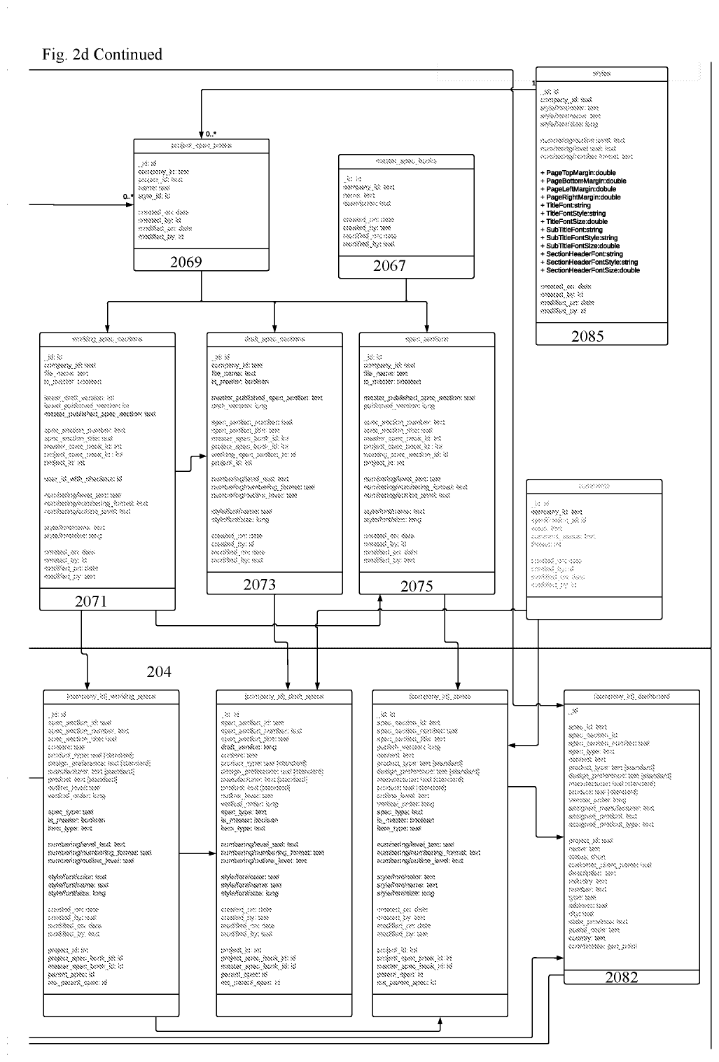

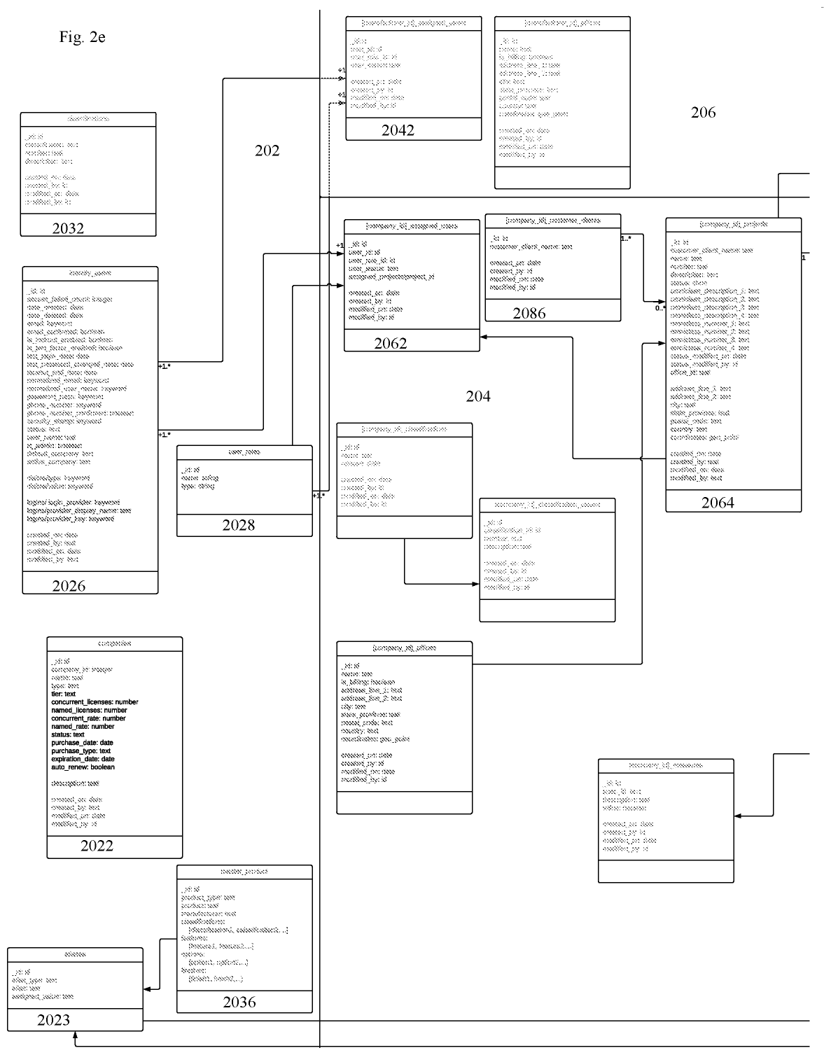

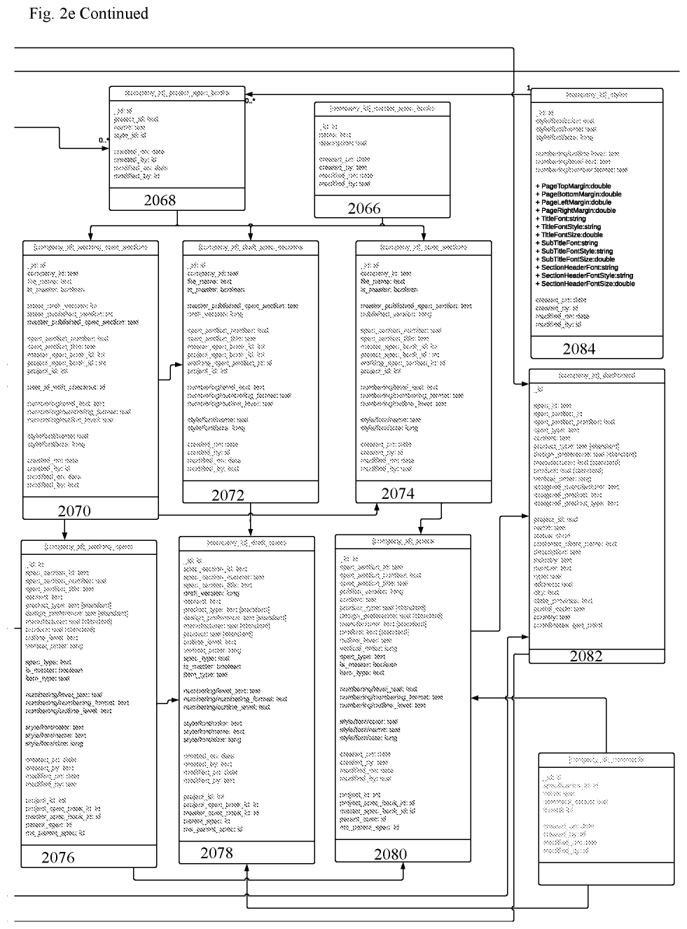

The computing device 112 of the first computing system includes a service provider database 142. The service provider database 142 is a NoSQL text-based database utilizing index patterns for searching. The database 142 processes text files (e.g. Word documents) and indexes the text files based on the text file properties, where an index having a desired index pattern is searched in connection with utilization of the system. The service provider database 142 is further described in FIG. 2.

The first computer system 102 is used by users associated with the service provider, where users have assigned user roles. Service provider user roles include an administrator. The administrator has view and edit rights to all of the service provider indices 202 (as further described in FIG. 2a). The administrator user role has view rights to the products index of the manufacturers indices 206 (as further described in FIG. 2a).

A second computer system 104 is associated with a designer that desires to use the system to prepare PSB. The second computer system 104 may include one or more computing devices (e.g. servers, nodes, computers). The second computer system 104 may include multiple computing devices, the multiple computing devices of the second computer system 104 may be connected to (e.g. communicatively coupled with) each other. In examples, the second computer system (e.g. designer computer system) 104 is remotely located from the first computer system (e.g. service provider computer system) 102.

The second computer system 104 is used by users associated with the designer, where users have assigned user roles. Designer user roles include a designer administrator, a specification writer, a master specification writer, and a specification viewer. The designer administrator user role has view and edit rights to all of the text files in the designer indices 204 (as described in FIG. 2a), and has view and edit rights to the create and edit designer users text files in the identity users index, and to view and edit the company name property in the company index.

The project administrator user role has view and edit rights to the text files in the customer clients index, the styles index, the projects index, the specifications sections index and the specification index of the designer indices 204.

The master specification writer user role has view and edit rights to the text files in the master specification books index, the specification sections index, and the specifications index of the designer indices 204.

The specification writer user role has view and edit right to the text files in the specification sections index, specifications index, and projects index of the designer indices 204.

The specification viewer user role has view rights to the text files in the specification section index, specifications index, and projects index of the designer indices 204. All designer user roles have view rights to the products index of the manufacturers indices 206.

The system may include a third computer system 106 that may be associated with a product manufacturer that supplies products used in connection with projects. The third computer system 106 may include one or more computing devices (e.g. servers, nodes, computers). The third computer system 106 may include multiple computing devices, the multiple computing devices of the third computer system 106 may be connected to (e.g. communicatively coupled with) each other. For example, the third computer system (e.g. manufacturer computer system) 106 is remotely located from the first computer system (e.g. service provider computer system) 102.

The third computer system 106 is used by users associated with the manufacturer, where users have assigned user roles. Manufacturer user roles include a manufacturer administrator and a manufacturer user. The manufacturer administrator user role has view and edit rights to all of the text files in the manufacturer indices 206 (as described in FIG. 2a), and has view and edit rights to the create and edit manufacturer users text files in the identity users index, and to view and edit the manufacturer name property in the company index of the service provider indices 202.

The manufacturer user role has view and edits rights in all of the text files in the manufacturer indices 206. All manufacturer user roles have view rights to the products index of the manufacturers indices 206.

FIG. 2a is a class diagram of a service provider database of the system for PSB creation and reporting use of product types on a geographic basis. For purposes of readability, the text of each index of FIG. 2a is listed in paragraph [0187]. The class diagram 200 of the service provider database includes service provider indices 202, manufacturer indices 204, and designer indices 206. The database 142 is a NoSQL text-based database utilizing index patterns for searching utilized to deploy the system for PSB creation and reporting use of product types on a geographic basis. For example, the NoSQL text-based database utilized to deploy the system may be a Elasticsearch database or MongoDB database. Searches executed on the database 142 use full text inverted index searches, which provide increased searching speed as compared to using a relational database for such data classification and searching. For example, executing a search (query) on the reporting specifications index 2082 takes approximately 1 second on the database 142, where utilizing a relational database to perform a similar search (i.e. using relational tables to search multiple tables via keys) would take approximately 40 seconds.

In connection with FIG. 2a, FIG. 2d, and FIG. 2e use of i.e. in parentheses identifies the property values of the associated index of the class diagram in FIG. 2a when the property value has a differing name in the class diagram as compared to this detailed description. The service provider indices 202 include indices relating to designers, manufacturers, and the both designers and manufacturers. The service provider indices 202 relate information between users and manufacturers and designers via index searching to facilitate the ability to provide real-time information for use of product types on a geographic basis and efficient preparation of a PSB.

The service provider indices 202 related to designers includes an index for companies. The companies index 2022 includes text files for each designer (company), where properties associated with each designer text file may include a companies index id that identifies the companies index (i.e. companies), a unique company id (_id:id), the company name, and the date the text file in the index was created. The companies index 2022 allows the service provider to index and manage the designers and their associated unique company ids. The unique company ids provide the ability for index pattern searches where a user associated with a particular designer will only search those indices having the unique company id in the index pattern.

The service provider indices 202 related to manufacturers includes an index for manufacturers. The manufacturers index 2024 includes text files for each manufacturer, where index properties associated with each manufacturer text file may include a manufacturers index id (i.e. manufacturers) that identifies the manufacturers, include a unique manufacturer id (i.e. _id:id), the company name, and the date the text file in the index was created. The manufacturers index allows the service provider to index and manage the manufacturers and their associated unique manufacturer ids. The unique manufacturer ids provide the ability for index pattern searches where a user associated with a particular manufacturer will only search those indices having the unique manufacturer id in the index pattern.

The service provider indices 202 related to both manufacturers and designers include user identity 2026, user rolls 2028, classification value 2030, and classifications 2032, and may include a master product index 2036. The identity users index 2026 includes text files for each user associated with at least one designer or manufacturer. The properties associated with each text file may include the identity users index id (i.e. identity_users), a unique user id (i.e. _id:id), username and password for the user to login to the system, a user's email address, Boolean of a user's administrator status, user status, and the date the text file in the index for the user was created. The identity users index 2026 provides top level management for access to the system by users associated with designers and manufacturers, where association of a company id or manufacturer id with a user (via assignment by a manufacturer in its manufacturer assigned users index 2042 and via assignment by a designer in its company assigned users index 2062) provides the ability for the user to query indexes having those particular company id and manufacturer id index patterns. Because one user may be associated with multiple designers or manufacturers, the identify users index 2026 includes a text file for each user, where the manufacturer or designer controls user access by assignment of a user role within the respect assigned users index. For example, a user being associated with both a company and manufacturer will generate two text files, one in the manufacturer assigned users index 2042 and one in the company assigned users index 2062, each having the respective listed properties.

The user roles index 2028 includes text files for each user role of manufacturers and companies (i.e. master specification writer, project specification writer, administrator). The properties associated with each text file may include a user role index id that identifies user roles index 2028, a user role id (i.e. _id:id) that identifies the a particular user role, and the name of the user role.

The classification index 2032 of the service provider indices 202 includes text files for each product. The properties associated with each text file may include the classification index id (i.e. classifications) that the classification index 2032, the classification id (i.e. _id:id) that identifies the product, the product name (i.e. name: text), and a release date of the product. The product name identifies a particular product. Two or more equivalent products may share a classification id, which allows equivalent products to be identified by having the same classification id. The classification index 2032 may deploy classification machine learning, such as the classification tool enabled within the Elasticsearch database to predict product classification ids for products.

The classification value index 2030 of the service provider indices 202 includes text files that relate products to specification sections utilizing a specification section number. The properties associated with each text file may include the classification index id that identifies the classification value index 2030 (i.e. classification_values), a classification value id (i.e. _id:id) that identifies the product's classification, the classification id (i.e. classification_id:id) that identifies a text file of the classifications index 2030, and a specification section number (i.e. number:text) that identifies the location of the text file when building a PSB, a description of the product, and the date the text file was created. The classification values index may deploy classification machine learning, such as the classification tool enabled within the Elasticsearch database to predict associations between products and specification sections.

The master product index 2036 includes text files for each manufacturer product in the reporting index 2082. The properties associated with each text file include master product index id that identifies the master product index 2036 (i.e. master_product), a master product id (i.e. _id:id) that identifies a particular product, a product name (i.e. product:text), product type, and manufacturer. The product name property as copied from the reporting index is the designer assigned product name, which may deviate from the service provider's assigned product name. The first computer system 102 may deploy K-means data clustering within the master product index, where the system assigns each product a value corresponding to the service provider's assigned product name. As the master product index 2036 is updated, the system deploys k-means data clustering to group each product name with its most closely associated service provider assigned product name, where each product then receives a system assigned value. This allows for increased accuracy in product identification by the manufacturer when it conducts a search, as product name deviations and aliases are identified by the system. Additionally, the master product index 2036 increases the searching speed in connection with a manufacturer's product search, as compared to a system not having the master product index.

The manufacturer indices 204 includes information relating to each particular manufacturer. The manufacturer indices 204 are replicated for each manufacturer utilizing the manufacturer's manufacturer id as the index pattern. The manufacturer indices 204 may include manufacturer assigned users 2042, manufacturer products 2044, manufacturer classification references 2046, product features 2048, product options 2050, and product finishes 2052. The manufacturer indices 204 may also include information on the manufacturer's offices, and the manufacturer's assigned users. Alternatively, the manufacturer indices 204 may be consolidated into the service provider indices 202, as represented in FIG. 2d.

The manufacturer assigned users index 2042 of the manufacturer indices 204 includes text files for each user having an unique user identity id associated with the manufacturer id, where the association is assigned by the manufacturer. The properties associated with each text file of the manufacturer assigned users index may include the manufacturer assigned users index id that identifies a particular index of the assigned users index (i.e. [manufacturer_id]_assigned_users), the assigned users id (i.e. _id:id) that identifies the user in the assigned users index 2042, the unique user id (i.e. user_id:id) that identifies the user, a user role index id (i.e. user_role_id:id) to identify the manufacturer user role, a user status, and the date the text file was created in the manufacturer assigned users index. Users in the manufacturer assigned users index are permissioned to search the manufacture's indices having the associated manufacturer id and update such indices with additional product information. Alternatively, the manufacturer assigned users index 2042 may be consolidated into the consolidated assigned users index 2063 of the service provider indices 202.

The manufacturer products index 2044 of the manufacturer indices 204 includes text files for each of the manufacturer's products. The properties associated with each product text file may include a product index id that identifies an index of the manufacturer products index 2044 (i.e. [manufacturer_id]_products), a product id (i.e. _id:id) which is the manufacture's product identification value, a product name, product type, product line, and a link to a website associated with the product. A manufacturer may manually populate the manufacturer products index with its products and associated properties. The manufacturer products index 2044 is utilized to populate the classification values index 2030 of the service provider indices 202 via the manufacturer classification reference index 2046 of the manufacturer indices 204. Alternatively, the manufacturer products index 2044 may be consolidated into the consolidated master product index 2045 of the service provider indices 202.

The manufacturer classification references index 2046 includes text files that relate a manufacturer's product with specification sections of designer PSB and MSB. The properties associated with each text file may include the classification reference index id that identifies the manufacturer's classification references index 2046 (i.e. [manufacturer_id]_classificationrefs), the classification reference id (i.e. _id:id) that identifies the classification references, the classification value id (i.e. classvalue_id:id) that identifies the associated text file of the classification values index, the product id that identifies the product, and the date on which the text file was created. The manufacturer classification reference index may be populated manually or the index may deploy classification machine learning, such as the classification tool enabled within the Elasticsearch database to classify products. Alternatively, the manufacturer classification references index 2046 may be consolidated into the consolidated master product index 2045 of the service provider indices 202.

The manufacturer indices 204 may also include additional indices having properties containing additional information on product features, such as product features 2048, product options (i.e. product add-ons) 2050, and product finishes 2052. These indices identify the product using the product id. Alternatively, the product features index 2048, product options index 2050, and product finishes index 2052 may be consolidated into the consolidated master product index 2045 of the service provider indices 202.

The designer indices 206 include information relating to a designer's MSB and PSB. The designer indices 206 include company assigned users 2062, projects 2064, PSB 2068, MSB 2066, published specification sections 2074, published specifications 2080, working specification section 2070, working specifications 2076, draft specification sections 2072, and draft specifications 2078 indices. The designer indices 206 may further include reporting 2082 customer clients 2086 indices.

The company assigned users index 2062 of the designer indices 206 includes text files for each user having a having an unique user identity id associated with the company id, where the association is assigned by the company. The properties associated with each text file of the company assigned users index may include the assigned users index id that identifies the company assigned users index 2062 (i.e. [company_id]_assigned_users), the unique user id that identifies the user (i.e. user_id:id), the user role id (i.e. user_role_id:id) to identify the designer user role, the user status, the project id that identifies projects associated with the user from the projects index 2064, and the date the text file was created in the company assigned users index. Users in the company assigned users index are permissioned to search the company's indices having the associated company id. Users in the company assigned users index may also be permissioned via the user role id to update such indices with additional product information (as described in FIG. 1). Alternatively, the company assigned users index 2062 may be consolidated into the consolidated assigned users index 2063 of the service provider indices 202.

The project index 2064 of the designer indices 206 includes text files of each project associated with a company. The properties associated with each project text file of the project index 2064 may include a project index id that identifies the project index (i.e. [company_id]_projects), the project id (i.e. _id:id) that identifies a particular project text file of the project index 2064, the customer client name, a project name (i.e. name:text), a project address, and the date the project was created. The project index 2064 may further include properties associated with the text file that relate to the industry and type of project. Classification of the project text file in this manner associates the project with its particular geography (via the address information), as well as the applicable specifications via the project id. Alternatively, the project indices 2064 may be consolidated into the consolidated project index 2065 of the service provider indices 202.

The designer indices 206 also include an MSB index 2066 that includes text files for an MSB. The properties associated with each MSB text file may include an MSB index id that identifies the MSB index 2066 (i.e. [company_id]_master_spec_books), an MSB id (i.e. _id:id) that identifies a particular MSB, the name of the MSB, and the date on which the text file was created in the index. The MSB index 2066 may further include a properties related to the description of the MSB. The MSB index 2066 provides classification of MSBs for use in connection with efficiently preparing a PSB and provides through the MSB id an association of the particular MSB text file with the associated specification sections text files of the working specification section 2070, draft specification section 2072, and published specification section 2074 indices. The MSB index 2066 may provide through the MSB id an association of the particular MSB text file with the associated specification text files of the working specifications 2076, draft specification 2078, published specification 2080. Alternatively, the MSB indices 2066 may be consolidated into the consolidated MSB index 2067 of the service provider indices 202.

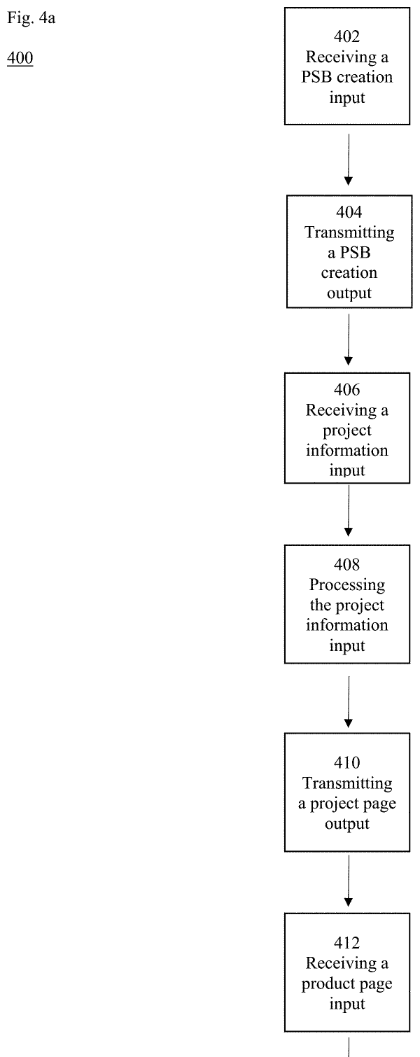

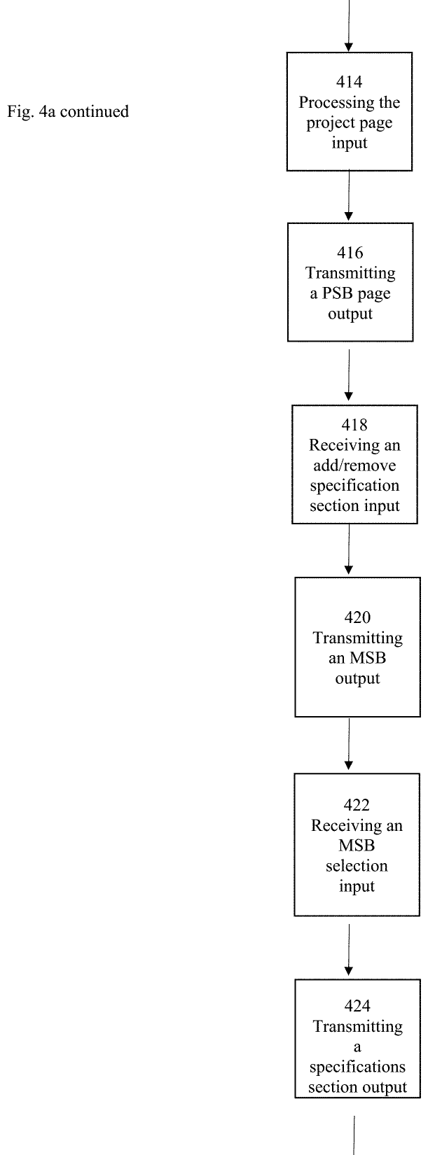

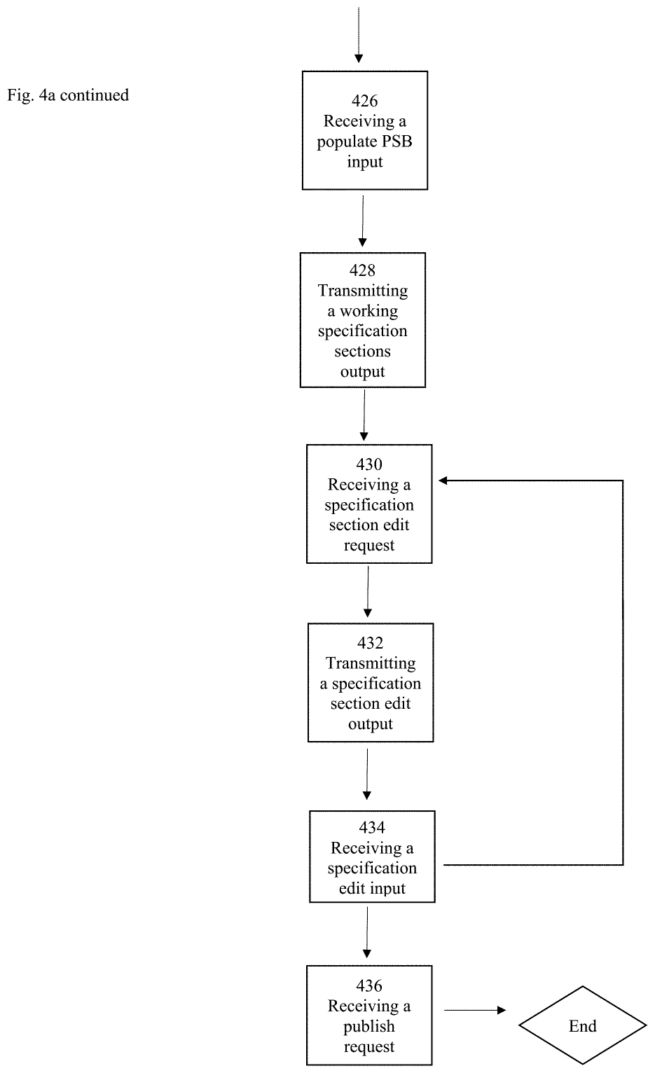

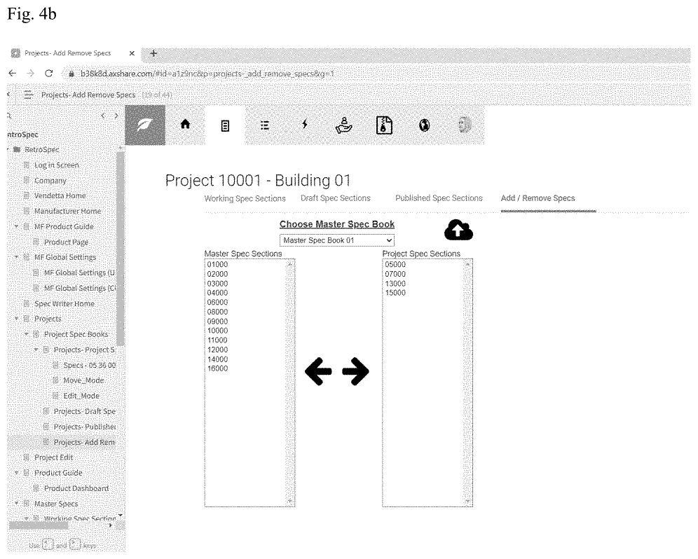

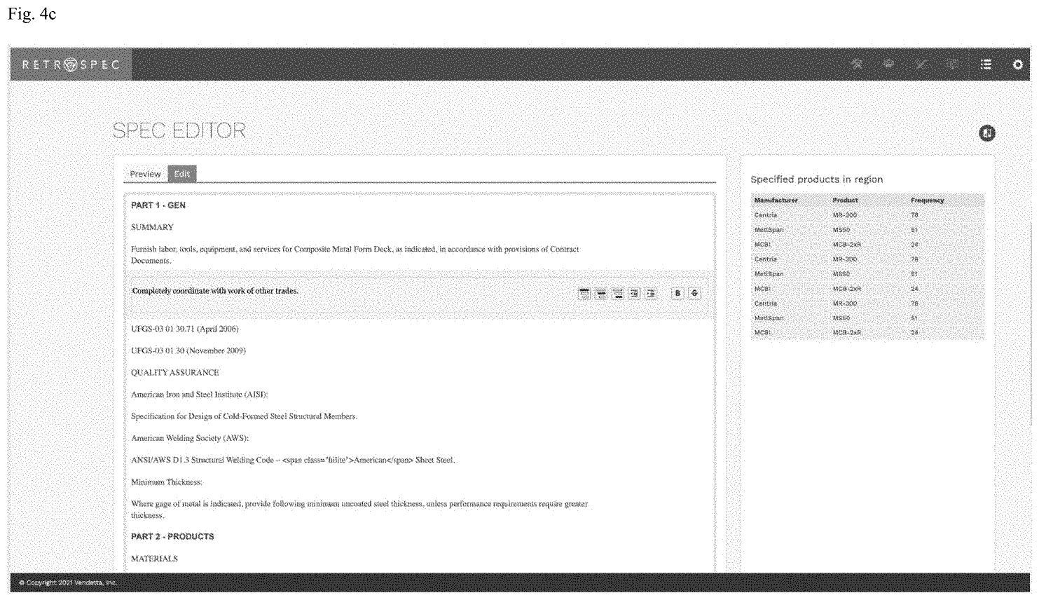

The designer indices 206 also include a PSB index 2068 that includes a text file for each of the PSBs associated with each module of a project. A new text file in the PSB index 2068 is created for each module of a project during PSB creation, as further detailed in FIG. 4. The properties associated with each text file of the PSB index 2068 may include a PSB index id that identifies the PSB index 2068 (i.e. [company_id]_project_spec_books), a PSB id (i.e. _id:id) that identifies a particular PSB, a PSB name, the project id, the style id, the date of creation of the text file, and the date the text file is modified and the unique user id of the user that created or modified the PSB(i.e. created_by:id and modified_by:id, respectively). The PSB index 2068 provides through the PSB id an association of the particular PSB with the associated specification sections text files of the working specification section 2070, draft specification section 2072, and published specification section 2074 indices. The PSB index 2068 may provide through the PSB id an association of the particular PSB with the association specification text file of the working specifications 2076, draft specification 2078, published specification 2080. Alternatively, the PSB indices 2068 may be consolidated into the consolidated PSB index 2069 of the service provider indices 202.

The published specification sections index 2074 of the designer indices 206 includes text files for each specification section of an MSB and PSB. The properties associated with each published specification section text file may include a published specification section index id (i.e. [company_id]_spec_sections]) that identifies a particular index of the specification sections index 2074, a published specification section id (i.e. _id:id), a specification section title (i.e. spec_section_title: text), a specification section number (i.e. spec_section_number), the MSB id (i.e. master_spec_book_id:int)that identifies the associated MSB, and the PSB id (i.e. projection_spec_book_id:int) that identifies the associated PSB. The properties associated with each text file may further include the unique user id (i.e. user_id_with_checkout:id) that identifies the user working on the text file, a date of creation, a data of modification, style properties (i.e. number and font properties), and information on where the specification section text file is arranged in the MSB (i.e. parent_spec_section_id). The published specifications section index classifies properties of each specification section of an MSB and PSB allowing for further classification of specifications in the designer indices. Alternatively, the published spec sections index 2074 may be consolidated into the consolidated published spec sections index 2075 of the service provider indices 202.

The designer indices 206 also include a working specification sections index 2070 that includes text files of each specification section associated with a particular PSB and MSB. New working specification sections text files are created for each project during PSB creation in the working specification section index 2070, as further detailed in FIG. 4. The properties associated with each text file in the working specifications section index may include the working specification sections index id that identifies the particular index of working specification section index 2070 (i.e. [company_id]_working_spec_sections), the PSB id (i.e. spec_book_id:int) that identifies the associated PSB, the MSB id (i.e. master_spec_book_id:str) that identifies the associated MSB, the specification section number (i.e. spec_section_number), and the specification section title (i.e. spec_section_title: text), and the date of creation of the text file (i.e. created_on:date). The properties associated with each text file may further include the unique user id (i.e. user_id_with_checkout:id) that identifies the user working on the text file, a date of creation, a data of modification, style properties, and information on where the specification section text file is arranged in the MSB. The working specifications section classifies each specification section of the associated PSB as a separate text file for efficiently preparing a PSB. Alternatively, the working specification section indices 2070 may be consolidated into a consolidated work spec section index 2071.

The published specifications index 2080 of the designer indices 206 includes text files for each specification of the published specification section index 2074 having text files for each specification of the specification section of an MSB and PSB. The properties associated with each text file of the published specification index 2080 may include a published specifications index id that identifies a particular index of the published specifications index 2080 (i.e. [company_id]_id), the published specification id (i.e. _id:id), the published specification section id (i.e. spec_section_id:text), the specification section number (i.e. spec_section_number:text), the specification section title (i.e. spec_section_title:text), the published version the specification (i.e. publish_version:long), the content (the text of the specification) (i.e. content:text), the product type (i.e. poduct_type:text [standard]), the design preference (i.e. design_preference:text [standard]), the manufacturer (i.e. manufacturer:text [standard]), the product (i.e. porudct:text [standard]), the outline level, the specification type (e.g. general specification, product type, product, design preference, manufacture, instruction, or standard) (i.e. spect_type:text), the MSB id (i.e. master_spec_book_id:id), and the PSB id (i.e. project_spec_book_id:id). In instances where the property value is not associated with the specification, the property value will be null. For example, a specification that is an instruction will have a null product type property value.

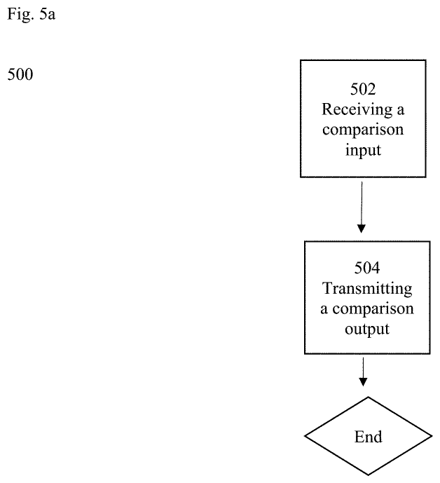

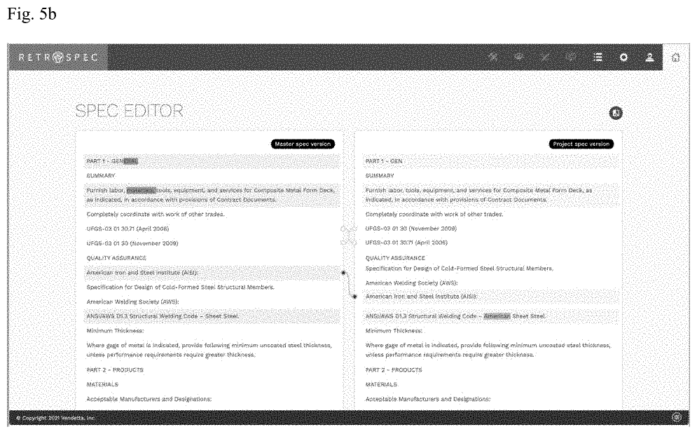

Each text file of the published specifications index 2080 further includes properties associated with the specification style (i.e. numbering and style properties), the ms parent spec id that identifies the specification text file of the MSB, and the parent spec id that identifies an associated specification that is the parent to the specification based upon the horizontal positioning in the specification section. When a specification is one horizontal position indent from the specification directly above, the specification directly above is a parent specification. The ms parent spec id allows identification of deviations from the MSB as compared to the PSB (as further described in FIG. 5a). Classification of a specification with these properties allows a user with an associated company id to query the indices having the same company id index pattern to efficiently build a PSB and compare a specification or specification sections against the MSB or another PSB.

The working specifications index 2076 of the designer indices 206 includes text files for each specification of the specification sections from the MSB and PSB. The properties associated with the text file may include a working specifications index id that identifies a particular index of the working specification index 2076 (i.e. [company_id]_working_specs), the working specification id (i.e. _id:id) that identifies the working specification text file, the working specification section id (i.e. spec_section_id:text) that identifies the associated working specification section text file, the specification section number (i.e. spec_section_number:text), the specification section title (i.e. spec_section_title:text), specification content (the text of the specification) (i.e. content:text), a product type (i.e. poduct_type:text [standard]), a design preference (i.e. design_preference: text [standard]), a manufacturer (i.e. manufacturer:text [standard], a product (i.e. product:text [standard]), an outline level, a specification type (e.g. general specification, product type, product, design preference, manufacture, instruction, or standard) (i.e. spec_type:text). In instances where the property value is not associated with the specification, the property value will be null. For example, a specification that is an instruction will have a null product type property value.

The text file may further includes properties associated with the specification style, the MSB id (i.e. master_spec_book_id:id) that identifies the associated MSB, the PSB id that identifies the associated PSB (i.e. project_spec_book_id:id), ms parent spec id that identifies the specification from the MSB, and the parent spec id that identifies an associated specification that is the parent to the specification based upon the horizontal positioning in the specification section. When a specification is one horizontal position indent from the specification directly above, the specification directly above is a parent specification. The ms parent spec id allows identification of deviations from the MSB as compared to the PSB. The working specifications index 2076 allows a user associated with a designer to efficiently build a PSB.

The designer indices 206 may also include a draft specification sections index 2072 that includes text files for each draft specification section. The properties associated with each text file in the draft specification sections index 2072 may include a draft specification sections index id that identifies a particular index of the draft specification sections index 2072 (i.e. [company_id]_draft_spec_sections, a draft specification sections id (i.e. _id:id) that identifies the text file of the draft specification sections index 2072, a working specification section index id (i.e. working_spec_section_id:id) that identifies the associated specification section from the working specification sections index 2070, a specification section number (i.e. spec_section_number:text), an MSB id (i.e. master_spec_book_id:str), and a PSB index id. The properties associated with each text file may further include the unique user id (i.e. userid_with_checkout:id) that identifies the user working on the text file, a date of creation, a data of modification, style properties, and information on where the specification section text file is arranged in the MSB. Alternatively, the draft specification sections indices may be consolidated into a consolidated draft spec sections index 2073.

The draft specifications index 2078 of the designer indices 206 includes text files for each draft specification of the draft specification sections from the MSB and PSB. The properties associated with a specification text file of the draft specifications index may include a draft specification index id that identifies a particular index of the draft specification index 2078 (i.e. [company_id]_draft_specs), the draft specification id (i.e. _id:id) that identifies the text file of the specification of the draft specifications index 2078), the draft specification section id (i.e. sepc_section_id: text), the specification section number (i.e. spec_section_number: text), the specification section title (i.e.)spec_section_title:text), the draft version (a numeric value that denotes the version of the draft specification) (i.e. draft_version:long), the specification content (the text of the specification) (i.e. content:text), the product type (i.e. product type: text [standard]), the design preference (i.e. design_preference: text[standard]), the manufacturer (i.e. manufactuer:text[standard]), the product (i.e. product:text[standard]), the outline level, the specification type (e.g. general specification, product type, product, design preference, manufacture, instruction, or standard) (i.e.spec_type: text). In instances where the property value is not associated with the specification, the property value will be null. For example, a specification that is an instruction will have a null product type property value.

The text file may further include properties associated with the specification style, the master specification book id (i.e. master_spec_book_id:id) to identify the associated MSB, the project specification book id (i.e. project_spec_book_id:id) to identify the associated PSB, a ms parent spec id, and the parent spec id. The ms parent spec id identifies the specification from the MSB, and the parent spec id that identifies an associated specification that is the parent to the specification based upon the horizontal positioning in the specification section. When a specification is one horizontal position indent from the specification directly above, the specification directly above is a parent specification. The ms parent spec id allows identification of deviations from the MSB as compared to the PSB. The draft specifications index may further be used to restore an associated text file of the specifications index to its prior version.

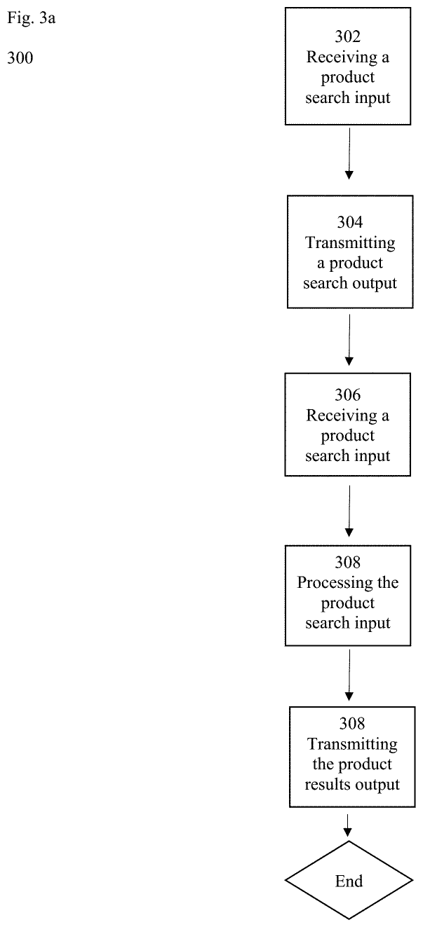

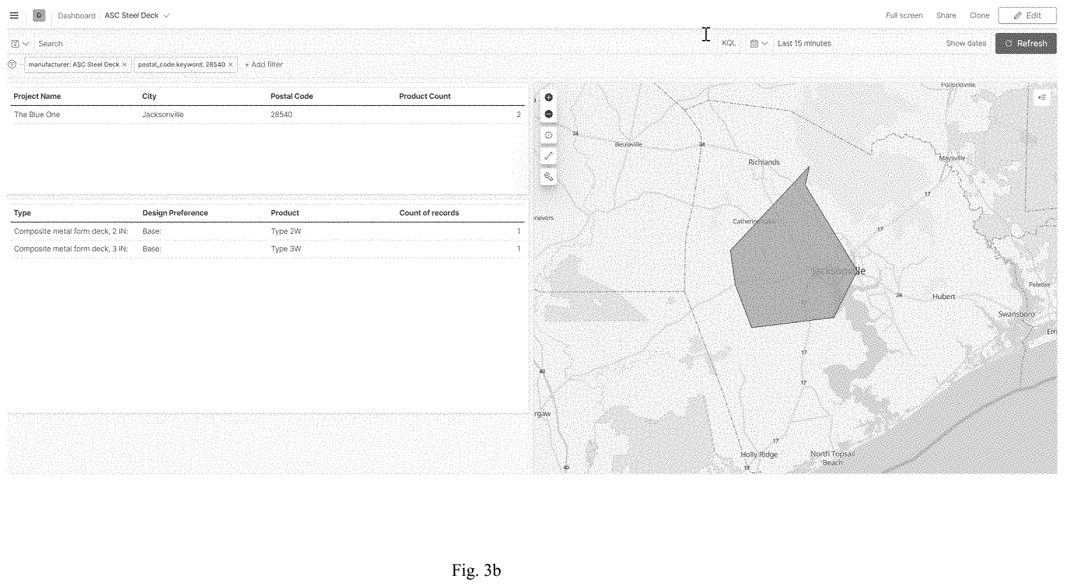

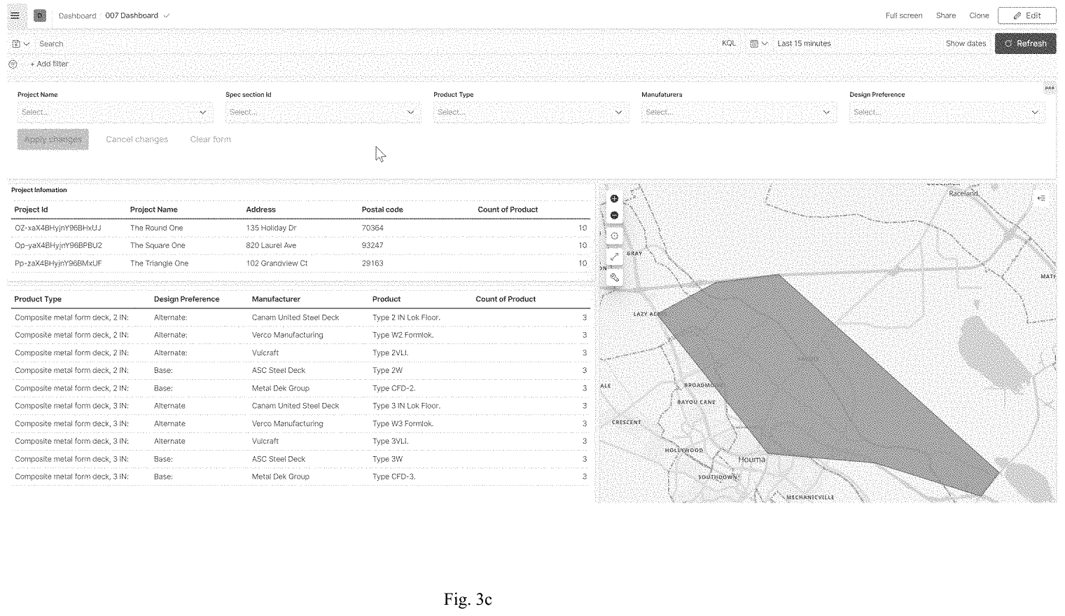

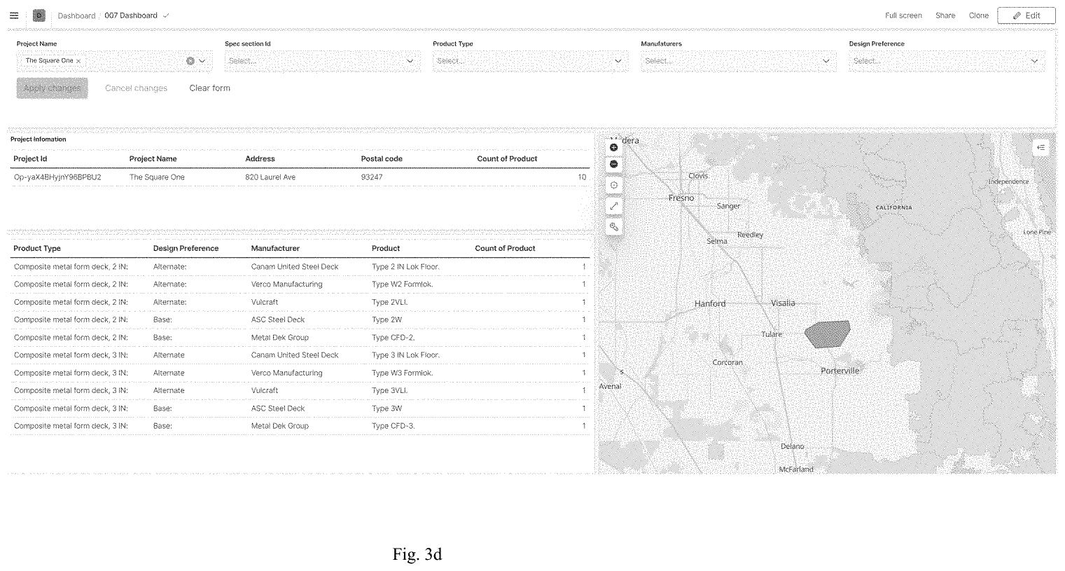

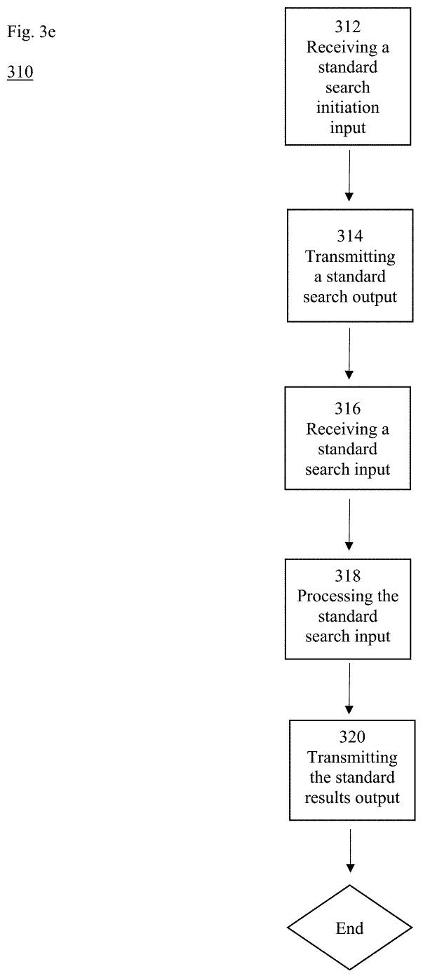

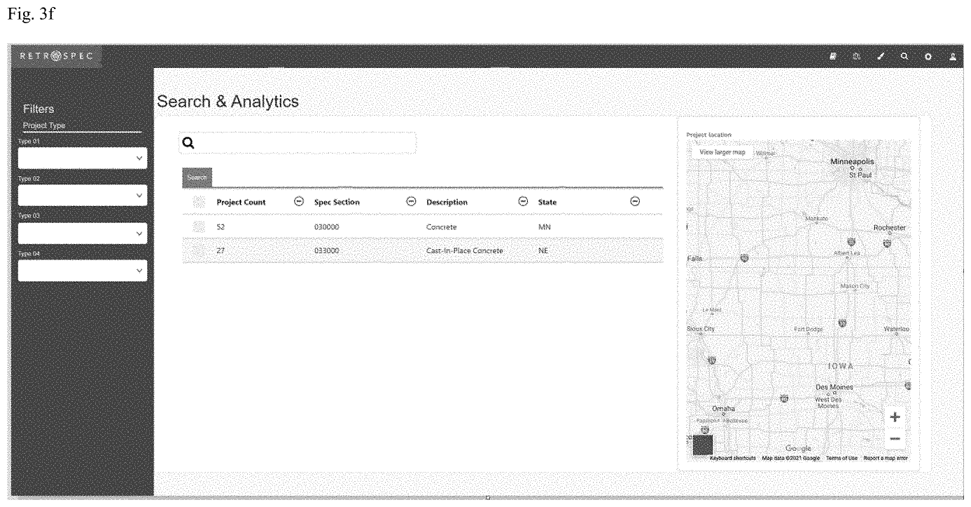

The reporting index 2082 of the designer indices 206 includes the combined text files from the published specifications index 2080 and the project index 2064. The reporting index 2082 includes a replication of each text file from the project index 2064, and a replication of the most current version of each published specification of the published specification index 2080. The reporting index 2082 associates a project from the project index 2064 with its corresponding specifications utilizing the PSB id. The reporting index classifies project address information as contained in the project index 2064 and product name information as contained in the specification index 2082. Classification of the projects and specification in this reporting index 2082 allows a manufacturer to query their manufacturer name (as further described in FIG. 3a) to return results for their associated products, which may then be filtered by geography. Classification of the projects and specifications in this reporting index 2082 further allows a designer to query their projects to return results for their associated projects (as further described in FIG. 3c), which may then be filtered by geography (as further described in FIG. 3d).

The designer indices 206 also include a styles index 2084 that includes text files for each style that may be applied to a PSB. The properties associated with each text file in the style index include a style index id that identifies a particular index of the styles index 2084 (i.e. [company id]_styles, the style id (i.e. _id:id), the font color, the font name, the font size, the outline level, the level text, the number format, and the date the text file is created. The style index 2084 allows selection of a style during project specification book creation, where the style is deployed in a uniform manner to the project specification book increasing the efficiency of project specification book creation. Alternatively, the styles indices 2084 may be consolidated into a consolidated styles index 2085.

The designer indices 206 also include a customer clients index 2086 that includes text files for each client of the designer. The properties associated with each text file include a customer clients index id that the customer clients index 2086 (i.e. [company_id]_customer_clients), a client id (i.e. _id:id) that identifies the client, a client name (i.e. customer_client_name: text), and the date the text file is created. The customer clients index allows a designer to have a listing of each of their clients' names. Alternatively, the customer clients indices 2086 may be consolidated into a consolidated customer clients index 2087.

FIG. 2b is a flow chart presenting a method 210 of classifying specifications. A user of the second computer system 104, such as project specification writer, may utilize the second computer system 104 to access a website associated with the service provider. Further, a web page of the web site including a login (i.e. the login credentials associate the user of a designer with their user role, user status, and company id) to upload files for inclusion in the service provider database 142 (e.g. icon, link, menu selection) may be displayed via a display of the second computer system 104. The user of the second computer system 104 may then provide an input which selects the file upload request, thereby causing the file upload request (i.e. the file upload input) to be transmitted to the first computer system 102 over the network 108.

In 212, the first computer system 102 receives the file upload input transmitted via a computer network 108 from a second computer system 104. The file upload input includes a request to begin file upload for classification.

In 214, in response to the file upload input, transmitting a file upload output to the second computer system 104 via the network 108. The file upload output is configured for causing a file upload instruction to be displayed, such as on a webpage. The file upload instruction is configured for uploading of a file, where the file type may be an MSB or style, and designation of the file type.

In 216, receiving a file input transmitted via a computer network 108 from the second computer system 104 based upon the file. The file provided in the file input is determined by a user of the second computer system. The user of the second computer system 104, determines the file for upload and designates file type for transmission of the file input to the first computer system 102 over the network 108 (i.e. MSB style).

In 218, the first computer system 102 processes the file input, in response to the file and file type designation of the file input. The processing includes classification of the file. In response to the file type designation the first computer system 102 then classifies the file into an index (i.e. MSB index 2066 or style index 2084). When the file type is an MSB the first computer system 102 classifies the MSB into the MSB index 2066 as a new text file. The first computer system then processes the uploaded MSB by copying the text files of the MSB into the working specification section index 2074, where each specification section is classified. The first computer system 102 then further processes the MSB, by coping text files of the MSB into the working specifications index 2076, such that specification of each specification section of the MSB is classified as a text file in the working specification index 2076. In response to a publish request, the processing may further include copying the text files having the assigned MSB id of the working specifications section index 2070 and working specifications index 2076 to the published specifications section index 2074 and published specifications index 2080 and assigned associated index properties.

When the file type is a style file, the first computer system 102 classifies the style into the styles index 2084. The first computer system 102 then processes the style file by creating a text file within the styles index 2084 and classifying each style within the file to assign the text file properties of the styles index to the file. In this way, a particular index of the styles index 2084 having classified styles may be applied to any PSB during creation (see FIG. 4) for uniform style across the PSB.

FIG. 2c is a flow chart presenting a method 220 of classifying products. A user of the third computer system 106, such as an employee of the manufacturer, may utilize the third computer system 106 to access the website associated with the service provider. Further, a web page of the website including a login (i.e. the login credentials associate the user of a designer with their user role, user status, and company id) to upload product information for inclusion in the service provider database 142 (e.g. icon, link, menu selection) may be displayed via a display of the third computer system 106. The user of the third computer system 106 may then provide an input which selects the product information upload request, thereby causing the product information request (i.e. the product information input) to be transmitted to the first computer system 102 over the network 108.

In 222, the first computer system 102 receives the product information input transmitted via a computer network 108 from a third computer system 106. The file upload input includes a request to begin file upload for classification.

In 224, in response to the product information input, transmitting a product information output to the second computer system 104 via the network 108. The product information output is configured for displaying a product information entry by the third computer system 106. The product information output is further configured for display by the third computer system 106, such as on the webpage through drop down menu, blank text box, scrolling menu, box selection, or the like.

In 226, receiving a product input transmitted via a computer network 108 from the third computer system 108 based upon a manufacture's product information. The product input is determined by the manufacturer in connection with information related to a product it manufactures. The product input includes information pertaining to the product, such as the product name, the product type, and the product title. The product input may further include information on the product features, options, finishes, and a link to a website associated with the product.

In 228, processing the product input by the first computer system 102. The processing is configured for classifying the product information of the product input into the product index 2044 of the manufacturer indices 204, where a text file for each product having the associated properties of the product index 2044 is created. The processing may further include classifying each product into the classification reference index 2046 of the manufacturer indices 204, where the particular product text file of the product index 2044 is copied into the classification reference index 2046 as an associated text file having the product id and is assigned a classification reference id, and other associated properties of the classification reference index 2046.

The processing may further include classifying the product into the features index 2048 of the manufacturer indices 204. The particular product text file index of the product index 2044 is copied into the features index 2048 where it is identified via its product id. The product text file in the features index 2048 is then available for the user to populate features of the product. The features index 2048 allows searching of products by a product's features.

The processing may further include classifying the product into the options index of the manufacturer indices 204. The particular product text file of the product index 2044 is copied into the options index 2050 as a text file where it is identified via its product id. The product text file in the options index 2050 is then available for the user to populate options of the product.

The processing may further include classifying the product into the finishes index of the manufacturer indices 204. The particular product text file of the product index 2044 is copied into the finishes index 2052 as a text file, where it is identified via its product id. The product text file in the finishes index 2052 is then available for the user to populate features of the product.

FIG. 2d represents a consolidated class diagram. For purposes of readability, the text of each index of FIG. 2d is listed in paragraph [0187]. In the consolidated class diagram, rather than index creation for each manufacturer or company's respective indices that are associated with the manufacturer or company by company id in the index pattern, these indices are consolidated into one index and are associated with the manufacturer or company by the company id as a property of the text file in the consolidated index. In the consolidated indices the searching occurs based on the text file property of the company id. In this manner, the association and respective searching occurs via the company id, as with the class diagram of FIG. 2a.

The consolidated assigned users index 2063 of the service provider indices 202 includes text files for each manufacturer and company user having an unique user identity id associated with the company id, where the association is assigned by the company. The properties associated with each text file of the consolidated assigned users index may include the consolidated assigned users index id that identifies the consolidated assigned users index 2063 (i.e. assigned users), the company id that identifies the manufacturer or company associated with the user (i.e. company_id: text), the unique user id that identifies the user (i.e. user_id:id), the user role id (i.e. user_role_id:id) to identify the designer user role, the user status, the assigned projects/project id that identifies projects associated with the user from the consolidated projects index 2065, and the date the text file was created in the consolidated assigned users index 2063. Users in the consolidated assigned users index 2063 are permissioned to search the indices having the associated company id. Users in the consolidated assigned users index may also be permissioned via the user role id to update such indices with additional product information (as described in FIG. 1).

The consolidated master product index 2045 includes text files for each manufacturer product in the reporting index 2082. The properties associated with each text file include a consolidated master product index id that identifies the master product index 2036 (i.e. master_product), a master product id (i.e. _id:id) that identifies a particular product, a company id that identifies the manufacturer or company associated with the user (i.e. company_id: text), a product name (i.e. product:text), product type, manufacturer, the classification (i.e. classifications:) that identifies all of the classifications for the particular product within specification sections of designer PSB and MSB, features (i.e. features:) that identifies features of the product, options (i.e. options:) that identifies options for the product, and finishes (i.e. finishes:) that identifies finishes for the product.

The product name property as copied from the reporting index is the designer assigned product name, which may deviate from the service provider's assigned product name. The first computer system 102 may deploy K-means data clustering within the master product index, where the system assigns each product a value corresponding to the service provider's assigned product name. As the master product index 2036 is updated, the system deploys k-means data clustering to group each product name with its most closely associated service provider assigned product name, where each product then receives a system assigned value. This allows for increased accuracy in product identification by the manufacturer when it conducts a search, as product name deviations and aliases are identified by the system. Additionally, the master product index 2036 increases the searching speed in connection with a manufacturer's product search, as compared to a system not having the master product index.

The consolidated project index 2065 includes text files of each project of all companies. The properties associated with each project text file of the consolidated project index 2065 may include a consolidated project index id that identifies the consolidated project index (i.e. projects), the company id (i.e. company_id:id) that identifies the company associated with the project text file, the project id (i.e. _id:id) that identifies a particular project text file of the consolidated project index 2065, the customer client name, a project name (i.e. name:text), a project address, and the date the project was created. The project index 2064 may further include properties associated with the text file that relate to the industry and type of project. Classification of the project text file in this manner associates the project with its particular geography (via the address information), as well as the applicable specifications via the project id.

The consolidated MSB index 2067 includes text files of MSB for all companies. The properties associated with each MSB text file may include a consolidated MSB index id that identifies the consolidated MSB index 2067 (i.e. master_spec_books), the company id (i.e. company_id:id) that identifies the company associated with the MSB text file, an MSB id (i.e. _id:id) that identifies a particular MSB, the name of the MSB, and the date on which the text file was created in the index. The consolidated MSB index 2067 may further include a properties related to the description of the MSB. The consolidated MSB index 2067 provides classification of MSBs for use in connection with efficiently preparing a PSB and provides through the MSB id an association of the particular MSB text file with the associated specification sections text files of the consolidated working specification section 2071, consolidated draft specification section 2073, and consolidated published specification section 2075 indices. The consolidated MSB index 2067 may provide through the MSB id an association of the particular MSB text file with the associated specification text files of the working specifications 2076, draft specification 2078, published specification 2080.

The consolidated PSB index 2069 includes text files of PSB for all companies. The properties associated with each PSB text file may include a consolidated PSB index id that identifies the consolidated PSB index 2069 (i.e. project_spec_books), the company id (i.e. company_id:id) that identifies the company associated with the PSB text file, a PSB id (i.e. _id:id) that identifies a particular PSB, a PSB name, the project id, the style id, the date of creation of the text file, and the date the text file is modified and the unique user id of the user that created or modified the PSB(i.e. created_by:id and modified_by:id, respectively). The consolidate PSB index 2069 provides through the PSB id an association of the particular PSB with the associated specification sections text files of the consolidated working specification section 2071, consolidated draft specification section 2073, and consolidated working published specification section 2075 indices. The consolidated PSB index 2069 may provide through the PSB id an association of the particular PSB with the association specification text file of the working specifications 2076, draft specification 2078, published specification 2080.

The consolidated published spec sections index 2075 includes text files for each specification section of an MSB and PSB for all companies. The properties associated with each consolidated published specification section text file may include a consolidated spec section index id (i.e. spec_sections) that identifies the consolidated published spec sections index 2075, the company id (i.e. company_id:id) that identifies the company associated with the consolidated published spec section text file, a published specification section id (i.e. _id:id), a specification section title (i.e. spec_section_title: text), a specification section number (i.e. spec_section_number), the MSB id (i.e. master_spec_book_id:int) that identifies the associated MSB, the PSB id (i.e. projection_spec_book_id:int) that identifies the associated PSB, and the project id (i.e. project_id:int) that identifies the associated project. The properties associated with each text file may further include, a date of creation, a data of modification, style properties (i.e. number and font properties), and information on where the specification section text file is arranged in the MSB (i.e. parent_spec_section_id). The published specifications section index classifies properties of each specification section of an MSB and PSB allowing for further classification of specifications in the designer indices.

The consolidated working spec section index 2071 includes text files of each specification section associated with a particular PSB and MSB for all companies. New working specification sections text files are created for each project during PSB creation in the working specification section index 2070, as further detailed in FIG. 4. The properties associated with each consolidated working spec section text file may include a consolidated working spec section index id (i.e. working spec sections) that identifies the consolidated working spec sections index 2071, the company id (i.e. company_id:id) that identifies the company associated with the consolidated published spec section text file, the PSB id (i.e. project_spec_book_id:int) that identifies the associated PSB, the MSB id (i.e. master_spec_book_id:int) that identifies the associated MSB, the specification section number (i.e. spec_section_number), and the specification section title (i.e. spec_section_title: text), and the date of creation of the text file (i.e. created_on:date). The PSB id and the MSB id properties identify the PSB and MSB that is associated with the respective specification section, which allows the first computer system 102 to utilize it as a filtering value searching for specification sections, to further speed searching by the first computer system 102. The properties associated with each text file may further include the unique user id (i.e. user_id_with_checkout:id) that identifies the user working on the text file, a date of creation, a data of modification, style properties, and information on where the specification section text file is arranged in the MSB. The consolidated working spec section classifies each specification section of the associated PSB as a separate text file for efficiently preparing a PSB.

In the consolidated class diagram of FIG. 2d, the published specifications index 2080 is the published specifications index of FIG. 2a, where the published specifications index id identifies a particular index of the published specifications index 2080 (i.e. [company_id]_id) that associates the particular index with a particular company.

The consolidated draft spec sections index 2073 includes text files of each draft specification section for all companies. The properties associated with each text file in the consolidated draft spec sections index 2073 include a consolidated spec sections index id that identifies the consolidated spec sections index 2073(i.e. draft spec sections), the company id (i.e. company_id:id) that identifies the company associated with the consolidated draft spec section text file, a draft specification sections id (i.e. _id:id) that identifies the text file of the consolidated draft spec sections index 2073, a working specification section index id (i.e. working_spec_section_id:id) that identifies the associated specification section from the consolidated working specification sections index 2071, a specification section number (i.e. spec_section_number:text), an MSB id (i.e. master_spec_book_id:int), and a PSB index id. The properties associated with each text file may further include the unique user id (i.e. userid_with_checkout:id) that identifies the user working on the text file, a date of creation, a data of modification, style properties, and information on where the specification section text file is arranged in the MSB.

In the consolidated class diagram of FIG. 2d, the draft specifications index 2078 is the draft specifications index of FIG. 2a, where the draft specifications index id identifies a particular index of the draft specifications index 2078 (i.e. [company_id]_id) that associates the particular index with a particular company.

In the consolidated class diagram of FIG. 2d, the reporting index 2082 is the reporting index of FIG. 2a, provided that the reporting index 2082 in the consolidated class diagram replicates each text file from the consolidated project index 2065 having the company id of the associated company indices 206. The reporting index 2082 of the class diagram and consolidated class diagram may include properties of assigned_manufacturer, assigned_product, and assigned_product_type that are assigned by the first computer system 102 in response to the K-means data clustering of the aliases index 2023. These assigned properties allow manufacturers and designers to specify the same product in their own vernacular, such that the same product may have a different manufacturer name (e.g. ABC Company, Inc. vs. ABC Company), while the first computer system will assign the same assigned_manufacturer property to each text file.

The aliases index 2023 of the consolidated class diagram is the aliases index 2023 of the second class diagram 201.

The consolidated styles index 2085 includes text files for each style that may be applied to a PSB for all companies. The properties associated with each text file in the consolidated style index 2085 include a consolidated style index id that identifies the styles index 2085 (i.e. styles), the company id (i.e. company_id:id) that identifies the company associated with the consolidated style text file, style id (i.e. _id:id), the font color, the font name, the font size, the outline level, the level text, the number format, and the date the text file is created. The consolidated style index 2085 allows selection of a style during project specification book creation, where the style is deployed in a uniform manner to the project specification book increasing the efficiency of project specification book creation.

The consolidated customer clients index 2087 includes text files for each client of the designer for all companies. The properties associated with each text file in the consolidated customer clients index 2087 include a consolidated customer client index id that identifies the consolidated customer clients index 2087 (i.e. customer_clients), the company id (i.e. company_id:id) that identifies the company associated with the consolidated customer client text file, a client id (i.e. _id:id) that identifies the client, a client name (i.e. customer_client_name: text), and the date the text file is created. The customer clients index allows a designer to have a listing of each of their clients' names.

FIG. 2e is a second class diagram 201 of a service provider database of the system for preparing PSB and reporting use of product types on a geographic basis. The second class diagram 201 includes the same indices as FIG. 2a and FIG. 2d as denoted by figure numeral and further includes the following index and text file properties. For purposes of readability, the text of each index of FIG. 2e is listed in paragraph [0188].

The second class diagram includes an aliases index 2023 of the service provider indices 202. The aliases index 2023 includes text files for each property of the reporting index 2082, where properties associated with the aliases index 2023 include an alias id (i.e. _id:id) that identifies the associate property of the reporting index (e.g. product, manufacturer), an alias (i.e. alias: text) that is the text of the user assigned value, and an assigned value (i.e. assigned_value: text) that is the first computer system 102 assigned value. Through K-means data clustering within the aliases index, the first computer system 102 assigns the assigned value property to each text file of the aliases index 2023 to allow users to maintain their own vernacular for specifying properties, such as product or manufacturer names.

The second class diagram includes an additional properties of the PSB id (i.e. project_spec_book_id:int) that identifies the associated PSB, the MSB id (i.e. master_spec_book_id:int) that identifies the associated MSB in the working specification sections index 2076, the draft specifications section index 2078, and the published specification sections index 2080. These properties identify the PSB and MSB that is associated with the respective specification section, which allows the first computer system 102 to utilize it as a filtering value searching for specification sections, to further speed searching by the first computer system 102.

The second class diagram 201 includes additional properties of assigned_manufacturer, assigned_product, and assigned_product_type that are assigned by the first computer system 102 in response to the K-means data clustering of the aliases index 2023.

FIG. 3a is a flow chart presenting a method of determining product use in a geographic area. A user of the third computer system 106, such as a personnel member of a manufacturer, may utilize the third computer system 106 to search the reporting index 2082 to determine use of a particular manufacturer product based on a geographic basis. Further, a web page of the website including a login (i.e. the login credentials associate the user of a manufacturer with their user role, user status, and manufacturer id) to begin determination of product use (e.g. icon, ink, menu selection) may be displayed via a display of the third computer system 106. The user of the third computer system 106 may then provide an input which selects the product search request, thereby causing the product search initiation request (i.e. product search initiation input) to be transmitted to the first computer system 102 over the network 108.

In 302, the first computer system 102 receives the product search initiation input from the third computer system 106 transmitted via the computer network 108. The product search initiation input includes the request to begin a product search for determining product use on a geographic basis.

In 304, in response to the product search initiation input, transmitting a product search output to the third computer system 106 via the network 108. The product search output is configured for displaying a product search entry by the third computer system 106, where the product search entry includes entry displays for the name of the product and geographic area (e.g. zip code, county, state, region, and the like). The product search entry may also include an entry display for the product type. The product search output is further configured for display by the third computer system 106, such as on the webpage through blank text box, drop down menu, auto-populating table, or the like for table filtering.

In 306, receiving a product search input transmitted via a computer network 108 from the second computer system 106. The product search input having product search information entered by the user of the third computer system 106 in response to the product that the manufacturer wants to search by geographic basis. For example, the product search information may include the product name and zip code of interest.

In 308, in response to the product search input, processing the product search input by the first computer system 102. The processing includes the first computer system conducting an inverted index search of the reporting index 2082 based on the manufacturer's name associated with the user, where each text file having the manufacturer's name as a property is identified.

The processing further includes filtering the identified text files having the manufacture's name based on the product name from the product entry of 306. The first computer system 102 utilizes the product name to filter, where due to the free text search, such products having naming variations will be identified based on the K-means data clustering in the master product index. The results of the product filtering will only include products from the manufacturer associated with the user. The processing further includes filtering the text files having matching product name and manufacturer names based on the project address corresponding to the desired geographic area, such that filtered results will only include products from the manufacturer associated with the user in the desired geographic area.

In 310, in response to the results of the processing of 308, transmitting the product results output to the third computer system 106 via the network 108. The product results output is configured to display product use information on the geographic basis, where product name and product volume is identified per geography. The product results output is further configured for display by the third computer system 106, such as on the webpage through numerical or graphical representations.

FIG. 3b is a mock-up of a display using fictional data generated only for example purposes of the result of the method for determining product use in a geographic area. In the upper left hand portion of the display there is a rectangular text box entry for entry of a manufacturer's product type (the product type filter), where a manufacturer may filter (search) based on its product type as in 304 of FIG. 3a. Directly adjacent to the product type text box there is rectangular text box entry for entry of a geography (geography filter), where a manufacturer may filter (search) by geography as in 304 of FIG. 3a.

On the right hand portion of the display that generally takes up the entirety of the right hand side of the display is a navigable map, preferably of the United States, that is navigable according to geographies (e.g. cities, zip codes, and the like). A particular geography is navigated to and highlighted based on the geography filter as in 304 of FIG. 3a. The selected geography may appear differentiated by a different color, as shown in FIG. 3b by the selection of zip code 28540 corresponding to Jacksonville.

Back on the left hand side of the display generally underneath the product type text box is a results display as in 310 of FIG. 3a. The results display includes a general results display having a first row that includes identifiers for the project name, city, postal code, and product count that indicates the total number of product specified in specification in the geography. In a second row of the results display the information pertaining to the search is displayed. In FIG. 3b, the project name is “The Blue One”, the city is “Jacksonville”, the Postal Code is 28540, and the Product Count is 2, indicating the manufacturer has two products specified in specifications in Jacksonville.

The results display further a detailed results display having a first row that includes identifiers for the type identifying the product type, design preference indicating whether the product is the base or alternate, product, and count of records identifying how many times a product is specified. The second row and ongoing rows of the detailed results display includes information associated with the identifiers in response to the search. In FIG. 3b the detailed results display displays information that includes two types, namely, “composite metal form deck, 2 IN:”, and “composite metal form deck, 3 IN:.” The other detailed results display identifiers include information associated with each type. For example, for the Composite metal form deck, 2IN: the design preference is base indicating that this is the base product for the specification, the product of Type 2W, where this information is in 1 specification in the geography. And for example, for the Composite metal form deck, 3IN: the design preference is base indicating that this is the base product for the specification, the product of Type 3W, where this information is in 1 specification in the geography.

FIG. 3c is a is a mock-up of a display using fictional data generated only for example purposes showing a designer dashboard that is generated using information from the reporting index 2082. At the top of the display there is a filter row having drop down text boxes that may be used to filter information from the reporting index 2082 based on the associated properties. This filter row includes titles and drop down menus for project name, spec section id, product type, manufactures, and design preference. When no filter is applied all of the information associated with the designer's projects is displayed in a project information display box.

The project information display box is generally below the filter row on the left hand side of the display. The project information display box includes a general project results display having identifiers for the project id, project name, address, postal code, and count of product, where this information from the reporting index is reflected in row form. For example, in the second row beneath the identifiers, the project id end in “BU2”, the project name “The Square One”, an address of 820 Laurel Ave. 93247, postal code 93247, and count of product 10 (indicating that 10 products are used in this project).

The project information display box includes a detailed project results display that includes detailed information on project products having identifiers for the product type, design preference, manufacturer, product and count of product, where this information from the reporting index is reflected in row form. For example, in the first row under the identifiers row, there is a product type of “composite metal form deck, 2 IN:”, a design preference of “alternate:” (indicating the product is an alternate, manufacturer of “Canam United Steel Deck”, product type of Type 2 IN Lok Floro. and count of product of “3” indicating the product is used in 3 specifications.

On the right hand portion of the display that generally takes up the entirety of the right hand side of the display is a navigable map, preferably of the United States, that is navigable according to geographies (e.g. cities, zip codes, and the like). When no filters are selected the map does not apply to any corresponding geography, but may reflect a highlighted area. For example, in FIG. 3c, the zip code of 70364 is highlighted.

FIG. 3d is a mock-up of a display using fictional data generated only for example purposes showing a designer dashboard applying a filter that is generated using information from the reporting index 2082. At the top of the display there is a filter row having drop down text boxes that may be used to filter information from the reporting index 2082 based on the associated properties. This filter row includes titles and drop down menus for project name, spec section id, product type, manufactures, and design preference. In FIG. 3d the project name filter is applies specifying “The Square One”, which then influences the information displayed in the project information display box.

The project information display box is generally below the filter row on the left hand side of the display. The project information display box includes a general project results display having identifiers for the project id, project name, address, postal code, and count of product, where this information from the reporting index is reflected in row form. For example, with the project name filter applied only information associated with the project name is displayed, namely the project id end in “BU2”, the project name “The Square One”, an address of 820 Laurel Ave. 93247, postal code 93247, and count of product 10 (indicating that 10 products are used in this project).

The project information display box includes a detailed project results display that includes detailed information on the filtered project products having identifiers for the product type, design preference, manufacturer, product and count of product, where this information from the reporting index is reflected in row form. For example, the information displayed is only that which is associated with the filtered project (The Square One) such that each product is used in the specifications for the filtered project, where the display shows which products are base or alternate products.

On the right hand portion of the display that generally takes up the entirety of the right hand side of the display is a navigable map, preferably of the United States, that is navigable according to geographies (e.g. cities, zip codes, and the like). For example, in FIG. 3d, with the project filter applied the zip code highlighted is that associated with the project, namely 93247.

FIG. 3e is a flow chart presenting a method 310 of determining standards used in a geographic area. A user of the third computer system 106, such as a personnel member of a manufacturer, may utilize the third computer system 106 to search the reporting index 2082 to determine use of a particular standard (i.e. ANSI standard, keywords related to a product (e.g. if the desired product is a particular refrigerated door, the keyword may be “refrigerator door”), or keywords related to project attributes (e.g. material type, temperature tolerances, weather tolerances, and the like)) on a geographic basis. Further, a web page of the website including a login (i.e. the login credentials associate the user of a manufacturer with their user role, user status, and manufacturer id) to begin determination of standard use (e.g. icon, ink, menu selection) may be displayed via a display of the third computer system 106. The user of the third computer system 106 may then provide an input which selects the standard search request, thereby causing the standard search initiation request (i.e. standard search initiation input) to be transmitted to the first computer system 102 over the network 108.

In 312, the first computer system 102 receives the standard search initiation input from the third computer system 106 transmitted via the computer network 108. The standard search initiation input includes the request to begin a standard search for determining standard use on a geographic basis.

In 314, in response to the standard search initiation input, transmitting a standard search output to the third computer system 106 via the network 108. The standard search output is configured for displaying a standard search entry by the third computer system 106, where the standard search entry includes entry displays for the name of the standard and geographic area (e.g. zip code, county, state, region, and the like). The standard search output is further configured for display by the third computer system 106, such as on the webpage through blank text box, drop down menu, auto-populating table, or the like for table filtering.

In 316, receiving a standard search input transmitted via a computer network 108 from the second computer system 106. The standard search input having product search information entered by the user of the third computer system 106 in response to the standard that the manufacturer wants to search by geographic basis. For example, the standard search information may include the ANSI standard and zip code of interest.

In 318, in response to the standard search input, processing the standard search input by the first computer system 102. The processing includes the first computer system conducting an inverted index search of the reporting index 2082.

The processing further includes filtering the text files of the reporting index 2082 based on the standard name from the standard entry of 316. The first computer system 102 utilizes the standard name to filter, where due to the free text search, such standards having naming variations will be identified based on the K-means data clustering in the aliases index, or the system assigned properties. The processing further includes filtering the text files having matching standard name based on the project address corresponding to the desired geographic area, such that filtered results will only include standard associated with the user in the desired geographic area. The processing further include filtering based on prohibited search terms, where if a user enters a search for a product name or manufacturer name, including any aliases, that they are not associated with via company id, those results will be filtered out.

In 320, in response to the results of the processing of 318, transmitting the standard results output to the third computer system 106 via the network 108. The standard results output is configured to display standard use information on the geographic basis, where standard name and standard volume is identified per geography. The standard results output is further configured for display by the third computer system 106, such as on the webpage through numerical or graphical representations.

FIG. 3f is a mock up a display using fictional data generated only for example purposes showing a manufacturer dashboard utilizing a standards search that is generated using information from the reporting index 2082. In FIG. 3d the standards searched for were “concrete” and “cast-in-place concrete” filtered for results in Minnesota and Nebraska respectively.

FIG. 4a is a flow chart presenting a method 400 of PSB creation. A user of the second computer system 104, such as a project specification writer, may utilize the second computer system 104 to access a website associated with the service provider. Further, a web page of the website including a login to begin PSB creation (e.g. icon, ink, menu selection) may be displayed via a display of the second computer system 104. The user of the second computer system 104 may then provide an input which selects the PSB creation request, thereby causing the PSB creation request (i.e. PSB creation input) to be transmitted to the first computer system 102 over the network 108.

In 402, the first computer system 102 receives the PSB creation input transmitted via the computer network 108 from the second computer system 104. The PSB creation input includes a request to begin PSB creation based upon a selection of an existing PSB.

In 404, in response to the PSB creation input, transmitting a PSB creation output to the second computer system 104 via the network 108. The PSB creation output is configured for displaying a project information entry by the second computer system 404, such as project name, client name, type of project, and project address. The PSB creation output is further configured for display by the second computer system 104, such as on the webpage through drop down menu, blank text box, scrolling menu, box selection, or the like.

In 406 receiving a project information input transmitted via a computer network 108 from the second computer system 106. The project information input having project information entered by the user of the second computer system 104 in response to the project for which the PSB is being created. For example, the project information include project name, client name, type of project, and project address. The project information input is configured for causing the first computer system to process the project information input.

In 408 processing the project information input by the first computer system 102 in response to the project information input. The processing includes creating a project text file having the associated properties for the project index 2064 of the designer indices 206, where the first computer system 102 assigns properties to the project text file from the project information input (i.e. project name and project address) and assigns generated properties to the project text file (i.e. project index id, project specification book id, and customer client id, project id).

In 410, in response to the processing of the project information input, transmitting a project page output to the second computer system 104 via the network 108, the project page output configured to display project information, such as the project name, a project module tab, and a style tab.

In 412, receiving a project page input transmitted from the second computer system 104 via the network 108. The project page input is determined by the user of the second computer system 104 to identify a PSB for each project module, and a style for each PSB. The project page input is configured for causing the first computer system 102 to process the project page input.

In 414, processing the project page input by the first computer system 102 in response to the project page input. The processing includes creating an text file in the PSB index 2068 for each module having the associated properties of the PSB index 2068 of the designer indices 206, where the first computer system 102 assigns properties to the PSB text file from the project page input (i.e. PSB name, style index id based on the selected style) and assigns generated properties to the project text file (i.e. PSB id, project id, and date created).

In 416, when a single PSB is associated with the project, transmitting a PSB page output to the second computer system 104 via the network 108, the PSB page output configured to display PSB information, such as the project name, a working specification sections tab, draft specification sections tab, published specification sections tab, and an add/remove specification sections tab.

In 418 receiving an add/remove specification section input transmitted from the second computer system 104 via the network 108. The add/remove specification section input is determined by the user of the second computer system 104 to initiate populating a PSB for the project. The add/remove specification section input is configured for causing the first computer system to lookup via inverted index search the MSBs associated with the user's company id from the MSB index 2066.

In 420, in response to the add/remove specification section input, transmitting an MSB output to the second computer system 104 via the network 108, the MSB output configured to display MSB by MSB name, such as on the webpage through drop down menu, scrolling menu, box selection, or the like. The MSB output displays the MSB name from the MSB index associated with the company id.

In 422, receiving an MSB selection input from the second computer system 104 via the network 108 based upon the selection of the MSB from the display of the MSB output. The MSB selection is determined by the user of the second computer system 104 in response to the project type and the MSB containing the specification sections pertaining to the module of the project for populating the PSB. The MSB selection input is configured for causing the first computer system 102 to process a search of the published specification sections index 2074 via inverted index search for specification section text files having an MSB id that is the MSB id of the selected MSB.

In 424, transmitting a specification sections output to the second computer system 104 via the network 108 based upon the results of the inverted index search of 416. The specification sections output is configured to display the specification section numbers of the specification sections from the published specification sections index 2074 having the associated MSB id. The specification section output is further configured for display by the second computer system 104, such as on the webpage through text box, drop down menu, scrolling menu, or the like. For example, the specification section output display may include a text box containing the specification section numbers whereby a user of the second computer system 104 may select and add the relevant specification sections to a text box for project specification sections as shown for example in FIG. 4b.

In 426, receiving a populate PSB input transmitted from the second computer system 104 via the network 108 based upon the selection of specification sections by the user of the second computer system 104. The specification sections selection is determined by the user of the second computer system 104 in response to the type and module of the project. The populate PSB input is configured for causing the first computer system 102 to process the selected specification sections by copying the text files of the associated specification sections from the published specification section index 2074 having the MSB id from 422 and the published specification section id associated with the selected specification sections into the working specification section index 2070 as new text files and assigning the PSB id from 414, a new working specification section id, and the MSB id from 422 to these copied specification sections. The assignment of the PSB id to the copied specification sections text files associates the specification sections with the PSB for the module of the project. The PSB input is further configured for causing the first computer system 102 to process the selected specifications associated with the selected specification sections by copying the text files of the associated specifications from the published specification index 2080 having the associated specification section id from 424 into the working specifications index 2076 as new text files and assigning a new working specification id and the properties from the published specification including the PSB id from 414, the MSB id from 422, the ms parent spec id, and parent spec id from the published specification to these copied specification sections. The assignment of the PSB id to the copied specification text files associates the specifications with the PSB of the project.

In 428 transmitting a working specification sections output to the second computer system 104 via the network 108 based upon the working specification section index of 426. The working specification sections output is configured to display an array of the specification sections of the associated working specifications index of 426. The array may include display of the specification section number, description, modification date, and user for each specification section. The working specification sections output is further configured for display by the second computer system 104, such as on the webpage.

In 430, receiving a specification section edit request input transmitted from the second computer system 104 via the network 108. The specification section edit request input may be determined by the user of the second computer system 104 in response to a specification section containing specifications that require modification based on the module of the project. The specification section edit request input is configured for causing the first computer system 102 to process the selected specification section to identify the specifications associated with the specification section from the working specifications index of 426 via inverted index search using the specification section id of the specification text files.

In 432, transmitting a specification section edit output to the second computer system 104 via the network 108. The specification section edit output is configured to display the specification identified in 430. The specification section edit output is further configured for display by the second computer system 104, such as on the webpage in an editable document format, as shown for example in FIG. 4c.

In 434, receiving a specification edit input from the second computer system 104 via the network 108. The specification edit input may be determined by the user of the second computer system 104 in response to a specification that requires modification based on the module of the project. The specification edit request input is configured for causing the first computer system 102 to process the specification edits, which save the edits in the working specifications index. Optionally, a draft input may be received from the second computer system 104, where the edited specification is saved in the draft specifications index as a new text file having the specification section id of 424 and other associated properties, such that the saved text file of the draft specifications index 2078 may be used to restore a text file of the working specification index 2076.

A user of the second computer system may repeat items 430-434 with the specification sections until completion of the edits to the specifications for the project. In response to this completion, in 436, receiving a publish request input from the second computer system 104 via the network 108. The publish request input is configured to cause the first computer system 102 to copy all text files from the working specification sections index of 434 and working specifications index of 434 as text files to the published specification sections index 2074, published specifications index 2080, including assigning the associated properties to each newly copied text file of the published specifications section and the published specifications. The processing further includes copying the working specification sections index and working specifications index of 434 as text files to the reporting index 2082, including assigning the associated properties to each text file. For multiple published versions of a PSB the reporting index only includes the most recent published version. The reporting index 2082 also assigns the project properties from 414 to the text files of the reporting index.

FIG. 5a is a flow chart representing a method 500 for comparing an MSB to a PSB in connection with a project to identify the modifications from the MSB to PSB and between a PSB and PSB when the PSBs share the same MSB. In 502 from the specification edit output page of 432 receiving a comparison input from the second computer system 104. When the comparison is a comparison of the PSB to the MSB, the comparison input is configured for causing the first computer system 102 to process the comparison, where the first computer system 102 compares the ms parent spec id of each specification in the specification section against the published specification id of all the specification text files of the published specification index 2080 of the PSB.

When the comparison is a comparison of two PSBs sharing the same MSB, the comparison input is configured for causing the first computer system 102 to process the comparison, where the first computer system 102 compares the ms parent spec id of each specification in the specification section against the published specification id of all of the specification text files of each of the published specification index 2080 for each PSB.

The comparison occurs when the ms parent spec id is equal to the published specification id the content properties of the text files are compared to determine differences in the specifications from the working specification section and the published specification section. Association of the ms parent spec id with the copied specifications in 426 allows tracking of the edits from specifications of the MSB to specifications of the PSB.

When PSBs sharing the same MSB are compared, the comparison input is further configured for causing the first computer system 102 to compare the result of the PSB to MSB comparison described in paragraphs [0174] and [0175] resulting in a PSB to PSB comparison. This comparison occurs as each of the ms parent spec ids of the PSB are equal to the published specification id of the MSB to allow content properties of the text files of each PSB to be compared to determine the differences in the specification from each working specification section of the PSB. Association of the ms parent spec id with the copied specifications in 426 allows tracking of the edits from specifications of the MSB to specifications of the PSB and subsequently against another PBS sharing the same MSB.

In 504 transmitting a comparison output from the first computer system 102 to the second computer system 104. The comparison output is configured to display the comparison between the specification of the MSB and the specification of the PSB processed in 502. The comparison output is further configured for display by the second computer system 104, such as on the webpage in an editable document format, as shown for example in FIG. 5b.

The text in each index of FIG. 2a is as follows:
2032
classifications
classification_id: id
name: text
release: date
created_on: date
created_by: id
modified_on: date
modified_by: id
2030
classification_values
classvalue_id: id
classification_id: id
number: text
description: text
created_on: date
created_by: id
modified_on: date
modified_by: id
2024
manufacturers
manufacturer_id: id
name: text
status: text
created_on: date
created_by: id
modified_on: date
modified_by: id
2026
identity_users
_id: id
access_failed_count: integer
date_created: date
date_deleted: date
email: keyword
email_confirmed: boolean
is_lockout_enabled: boolean
is_two_factor_enabled: boolean
last_login_date: date
last_password_changed_date: date
lockout_end_date: date
normalized_email: keyword
normalized_user_name: keyword
password_hash: keyword
phone_number: keyword
phone_number_confirmed: boolean
security_stamp: keyword
status: text
user_name: text
is_admin: boolean
claims/type: keyword
claims/value: keyword
logins/login_provider: keyword
logins/provider_display_name: text
logins/provider_key: keyword
roles/role_id: keyword
created_on: date
created_by: text
modified_on: date
modified_by: text
2028
user_roles
user_role_id: id
name: string
type: string
2022
companies
_id: id
company_id: integer
name: text
description: text
created_on: date
created_by: text
modified_on: date
modified_by: id
2036
master_product
_id: id
product type: text
product: text
manufacturer: text
2042
[manufacturer_id]_assigned_users
user_id: id
user_role_id: id
user_status: text
created_on: date
created_by: id
modified_on: date
modified_by: id
2062
[company id]_assigned_users
_id: id
user_role_id: id
user_status: text
project_id
created_on: date
created_by: id
modified_on: date
modified_by: id
[company id]_classifications
_id: id
name: text
release: date
created_on: date
created_by: id
modified_on: date
modified_by: id
[company id]_offices
_id: id
name: text
is_billing: boolean
address_line_1: text
address_line_2: text
city: text
state_province: text
postal_code: text
country: text
coordinates: geo_point
created_on: date
created_by: id
modified_on: date
modified_by: id
[manufacturer_id]_offices
office_id: id
name: text
is_billing: boolean
address_line_1: text
address_line_2: text
city: text
state_province: text
postal_code: text
country: text
coordinates: geo_point
created_on: date
created_by: id
modified_on: date
modified_by: id
2086
[company id]_customer_clients
_id: id
customer_client_name: text
created_on: date
created_by: id
modified_on: date
modified_by: id
[company id]_classification_values
_id: id
classification_id: id
number: text
description: text
created_on: date
created_by: id
modified_on: date
modified_by: id
2044
[manufacturer_id]_products
product_id: id
name: text
type: text
product_line: text
model_number: text
product_weblink:text
created_on: date
created_by: id
modified_on: date
modified_by: id
2064
[company id]_projects
_id: id
customer_client_name: text
name: text
number: text
description: text
status: short
industry: text
type: text
status_modified_on: date
status_modified_by: id
office_id: text
address_line_1: text
address_line_2: text
city: text
state_province: text
postal_code: text
country: text
coordinates: geo_point
created_on: date
created_by: text
modified_on: date
modified_by: text
2046
[manufacturer_id]_classificationrefs
classref_id: id
classvalue_id: id
product_id: id
created_on: date
created_by: id
modified_on: date
modified_by: id
2070
[company id]_working_spec_sections
_id: id
file_name: text
spec_book_id: int
is_master: boolean
latest_draft_version: int
latest_published_version: int
spec_section_number: text
spec_section_title: text
master_spec_book_id: str
spec_book_id: int
user_id_with_checkout: id
numbering/level_text: text
numbering/numbering_format: text
numbering/outline_level: text
style/font/name: text
style/font/size: long
created_on: date
created_by: id
modified_on: date
modified_by: text
2076
[company id]_working_specs
_id: id
spec_section_id: text
spec_section_number: text
spec_section_title: text
content: text
product_type: text [standard]
design_preference: text [standard]
manufacturer: text [standard]
product: text [standard]
outline_level: text
vertical_order: long
spec_type: text
is_master: boolean
item_type: text
numbering/level_text: text
numbering/numbering_format: text
numbering/outline_level: text
style/font/color: text
style/font/name: text
style/font/size: long
created_on: date
created_by: text
modified_on: date
modified_by: text
project_spec_book_id: id
master_spec_id: id
parent_spec: id
ms_parent_spec: id
2049
[manufacturer_id]_features
feature_id: id
product_id: id
name: text
description: text
created_on: date
created_by: id
modified_on: date
modified_by: id
2068
[company id]_project_spec_books
project_id: text
name: text
style id: id
created_on: date
created_by: id
modified_on: date
modified_by: id
2072
[company id]_draft_spec_sections
_id: id
file_name: text
is_master: boolean
draft_version: int
master_published_spec_section: text
parent_spec_section_id: str
draft_version: long
spec_section_number: text
spec_section_title: text
master_spec_book_id: str
working_spec_section_id: id
user_id_with_checkout: id
numbering/level_text: text
numbering/numbering_format: text
numbering/outline_level: text
style/font/name: text
style/font/size: long
created_on: date
created_by: id
modified_on: date
modified_by: text
2078
[company id]_draft_specs
_id: id
spec_section_id: text
spec_section_number: text
spec_section_title: text
draft_version: long
content: text
product_type: text [standard]
design_preference: text [standard]
manufacturer: text [standard]
product: text [standard]
outline_level: text
vertical_order: long
spec_type: text
is_master: boolean
item_type: text
numbering/level_text: text
numbering/numbering_format: text
numbering/outline_level: text
style/font/color: text
style/font/name: text
style/font/size: long
created_on: date
created_by: text
modified_on: date
modified_by: text
master_spec_book_id: id
project_spec_book_id: id
ms_parent_spec: id
parent_spec: id
2050
[manufacturer_id]_options
option_id: id
product_id: id
name: text
description: text
created_on: date
created_by: id
modified_on: date
modified_by: id
2066
[company_id]_master_spec_books
_id: id
name: text
description: text
created_on: date
created_by: text
modified_on: date
modified_by: text
2074
[company_id]_spec_sections
_id: id
file_name: text
is_master: boolean
draft_version: int
latest_published_version: long
master_published_spec_section: text
parent_spec_section_id: str
published_version: long
spec_section_number: text
spec_section_title: text
master_spec_book_id: int
project_spec_book_id: int
working_spec_section_id: id
user_id_with_checkout: id
numbering/level_text: text
numbering/numbering_format: text
numbering/outline_level: text
style/font/name: text
style/font/size: long
created_on: date
created_by: id
modified_on: date
modified_by: text
2080
[company_id]_specs
_id: id
spec_section_id: text
spec_section_number: text
spec_section_title: text
publish_version: long
content: text
product_type: text [standard]
design_preference: text [standard]
manufacturer: text [standard]
product: text [standard]
outline_level: text
vertical_order: long
spec_type: text
master_spec_number: text
is_master: boolean
item_type: text
numbering/level_text: text
numbering/numbering_format: text
numbering/outline_level: text
style/font/color: text
style/font/name: text
style/font/size: long
created_on: date
created_by: text
modified_on: date
modified_by: text
master_spec_book_id: id
project_spec_book_id: id
ms_parent_spec: id
parent_spec: id
2052
[manufacturer_id]_finishes
finish_id: id
product_id: id
name: text
description: text
created_on: date
created_by: id
modified_on: date
modified_by: id
2084
[company_id]_styles
_id: id
style/font/color: text
style/font/name: text
style/font/size: long
numbering/outline_level: text
numbering/level_text: text
numbering/number format: text
+ PageTopMargin:double
+ PageBottomMargin:double
+ PageLeftMargin:dobule
+ PageRightMargin:double
+ TitleFont:string
+ TitleFontStyle:string
+ TitleFontSize:double
+ SubTitleFont:string
+ SubTitleFontStyle:string
+ SubTitleFontSize:double
+ SectionHeaderFont:string
+ SectionHeaderFontStyle:string
+ SectionHeaderFontSize:double
created_on: date
created_by: id
modified_on: date
modified_by: id
2082
[company_id]_dashboard
_id
spec_id: text
spec_section_id
spec_section_number: text
spec_type: text
content: text
product_type: text [standard]
design_preference: text [standard]
manufacturer: text [standard]
product: text [standard]
vertical_order: long
project_id: text
name: text
status: short
customer_client_name: text
description: text
industry: text
number: text
type: text
address: text
city: text
state_province: text
postal_code: text
country: text
coordinates: geo_point
[company_id] comments
_id: id
specification_id: id
value: text
comment_status: text
thread: int
created_on: date
created_by: id
modified_on: date
modified_by: id

The text in each index of FIG. 2d is as follows:
global_classifications
_id: id
classification: text
number: text
description: text
created_on: date
created_by: id
modified_on: date
modified_by: id
2026
identity_users
_id: id
access_failed_count: integer
date_created: date
date_deleted: date
email: keyword
email_confirmed: boolean
is_lockout_enabled: boolean
is_two_factor_enabled: boolean
last_login_date: date
last_password_changed_date: date
lockout_end_date: date
normalized_email: keyword
normalized_user_name: keyword
password_hash: keyword
phone_number: keyword
phone_number_confirmed: boolean
security_stamp: keyword
status: text
user_name: text
is_admin: boolean
default_company: text
active_company: text
claims/type: keyword
claims/value: keyword
logins/login_provider: keyword
logins/provider_display_name: text
logins/provider_key: keyword
created_on: date
created_by: text
modified_on: date
modified_by: text
2022
companies
_id: id
company_id: integer
name: text
type: text
tier: text
concurrent_licenses: number
named_licenses: number
concurrent_rate: number
named_rate: number
status: text
purchase_date: date
purchase_type: text
expiration_date: date
auto_renew: boolean
description: text
created_on: date
created_by: text
modified_on: date
modified_by: id
2028
user_roles
_id: id
name: string
type: string
classification_values
_id: id
company_id: text
classification_id: id
number: text
description: text
created_on: date
created_by: id
modified_on: date
modified_by: id
customer_clients
_id: id
company_id: text
customer_client_name: text
created_on: date
created_by: id
modified_on: date
modified_by: id
2063
assigned_users
_id: id
company_id: text
user_id: id
user_role_id: id
user_status: text
assigned_projects/project_id
created_on: date
created_by: id
modified_on: date
modified_by: id
offices
_id: id
company_id: text
name: text
is_billing: boolean
address_line_1: text
address_line_2: text
city: text
state_province: text
postal_code: text
country: text
coordinates: geo_point
created_on: date
created_by: id
modified_on: date
modified_by: id
2065
projects
_id: id
company_id: text
customer_client_name: text
name: text
number: text
description: text
status: short
omniclass_description_1: text
omniclass_description_2: text
omniclass_description_3: text
omniclass_description_4: text
omniclass_number_1: text
omniclass_number_2: text
omniclass_number_3: text
omniclass_number_4: text
status_modified_on: date
status_modified_by: id
office_id: text
address_line_1: text
address_line_2: text
city: text
state_province: text
postal_code: text
country: text
coordinates: geo_point
created_on: date
created_by: text
modified_on: date
modified_by: text
measures
_id: id
company_id: text
spec_id: text
description: text
value: decimal
created_on: date
created_by: id
modified_on: date
modified_by: id
2045
master_product
_id: id
company_id: text
product_type: text
product: text
manufacturer: text
classifications:
[classification1, calssification2, . . . ]
features:
[feature1, feature2, . . . ]
options:
[option1, option2, . . . ]
finishes:
[finish1, finish2, . . . ]
2023
aliases
_id: id
alias_type: text
alias: text
assigned_value: text
2069
project_spec_books
_id: id
company_id: text
project_id: text
name: text
style_id: id
created_on: date
created_by: id
modified_on: date
modified_by: id
2071
working_spec_sections
_id: id
company_id: text
file_name: text
is_master: boolean
latest_draft_version: int
latest_published_version: int
master_published_spec_section: text
spec_section_number: text
spec_section_title: text
master_spec_book_id: int
project_spec_book_id: int
project_id: int
user_id_with_checkout: id
numbering/level_text: text
numbering/numbering_format: text
numbering/outline_level: text
style/font/name: text
style/font/size: long
created_on: date
created_by: id
modified_on: date
modified_by: text
[company_id]_working_specs
_id: id
spec_section_id: text
spec_section_number: text
spec_section_title: text
content: text
product_type: text [standard]
design_preference: text [standard]
manufacturer: text [standard]
product: text [standard]
outline_level: text
vertical_order: long
spec_type: text
is_master: boolean
item_type: text
numbering/level_text: text
numbering/numbering_format: text
numbering/outline_level: text
style/font/color: text
style/font/name: text
style/font/size: long
created_on: date
created_by: text
modified_on: date
modified_by: text
project_id: int
project_spec_book_id: id
master_spec_book_id: id
parent_spec: id
ms_parent_spec: id
2073
draft spec sections
_id: id
company_id: text
file_name: text
is_master: boolean
master_published_spec_section: text
draft_version: long
spec_section_number: text
spec_section_title: text
master_spec_book_id: int
project_spec_book_id: int
working_spec_section_id: id
project_id: int
numbering/level_text: text
numbering/numbering_format: text
numbering/outline_level: text
style/font/name: text
style/font/size: long
created_on: date
created_by: id
modified_on: date
modified_by: text
[company_id]_draft_specs
_id: id
spec_section_id: text
spec_section_number: text
spec_section_title: text
draft_version: long
content: text
product_type: text [standard]
design_preference: text [standard]
manufacturer: text [standard]
product: text [standard]
outline_level: text
vertical_order: long
spec_type: text
is_master: boolean
item_type: text
numbering/level_text: text
numbering/numbering_format: text
numbering/outline_level: text
style/font/color: text
style/font/name: text
style/font/size: long
created_on: date
created_by: text
modified_on: date
modified_by: text
project_id: int
project_spec_book_id: id
master_spec_book_id: id
parent_spec: id
ms_parent_spec: id
master_spec_books
_id: id
company_id: text
name: text
description: text
created_on: date
created_by: text
modified_on: date
modified_by: text
2067
master_spec_books
_id: id
company_id: text
name: text
description: text
created_on: date
created_by: text
modified_on: date
modified_by: text
2075
spec_sections
_id: id
company_id: text
file_name: text
is_master: boolean
master_published_spec_section: text
published_version: long
spec_section_number: text
spec_section_title: text
master_spec_book_id: int
project_spec_book_id: int
working_spec_section_id: id
project_id: int
numbering/level_text: text
numbering/numbering_format: text
numbering/outline_level: text
style/font/name: text
style/font/size: long
created_on: date
created_by: id
modified_on: date
modified_by: text
[company_id]_specs
spec_section_id: text
spec_section_number: text
spec_section_title: text
publish_version: long
content: text
product_type: text [standard]
design_preference: text [standard]
manufacturer: text [standard]
product: text [standard]
outline_level: text
vertical_order: long
spec_type: text
is_master: boolean
item_type: text
numbering/level_text: text
numbering/numbering_format: text
numbering/outline_level: text
style/font/color: text
style/font/name: text
style/font/size: long
created_on: date
created_by: text
modified_on: date
modified_by: text
project_id: int
project_spec_book_id: id
master_spec_book_id: id
parent_spec: id
ms_parent_spec: id
2085
styles
_id: id
company_id: text
style/font/color: text
style/font/name: text
style/font/size: long
numbering/outline_level: text
numbering/level_text: text
numbering/number format: text
+ PageTopMargin:double
+ PageBottomMargin:double
+ PageLeftMargin:dobule
+ PageRightMargin:double
+ TitleFont:string
+ TitleFontStyle:string
+ TitleFontSize:double
+ SubTitleFont:string
+ SubTitleFontStyle:string
+ SubTitleFontSize:double
+ SectionHeaderFont:string
+ SectionHeaderFontStyle:string
+ SectionHeaderFontSize:double
created_on: date
created_by: id
modified_on: date
modified_by: id
comments
_id: id
company_id: text
specification_id: id
value: text
comment_status: text
thread: int
created_on: date
created_by: id
modified_on: date
modified_by: id
2082
[company_id]_dashboard
_id
spec_id: text
spec_section_id
spec_section_number: text
spec_type: text
content: text
product_type: text [standard]
design_preference: text [standard]
manufacturer: text [standard]
product: text [standard]
vertical_order: long
assigned_manufacturer: text
assigned_product: text
assigned_prodcut type: text
project_id: text
name: text
status: short
customer_client_name: text
description: text
industry: text
number: text
type: text
address: text
city: text
state_province: text
postal_code: text
country: text
coordinates: geo_point
The text in each index of FIG. 2e is as follows:
2032
classifications
_id: id
classification: text
number: text
description: text
created_on: date
created_by: id
modified_on: date
modified_by: id
2026
identity_users
_id: id
access_failed_count: integer
date_created: date
date_deleted: date
email: keyword
email_confirmed: boolean
is_lockout_enabled: boolean
is_two_factor_enabled: boolean
last_login_date: date
last_password_changed_date: date
lockout_end_date: date
normalized_email: keyword
normalized_username: keyword
password_hash: keyword
phone_number: keyword
phone_number_confirmed: boolean
security_stamp: keyword
status: text
user_name: text
is_admin: boolean
default_company: text
active_company: text
claims/type: keyword
claims/value: keyword
logins/login_provider: keyword
logins/provider_display_name: text
logins/provider_key: keyword
created_on: date
created_by: text
modified_on: date
modified_by: text
2022
companies
_id: id
company_id: integer
name: text
type: text
tier: text
concurrent_licenses: number
named_licenses: number
concurrent_rate: number
named_rate: number
status: text
purchase_date: date
purchase_type: text
expiration_date: date
auto_renew: boolean
description: text
created_on: date
created_by: text
modified_on: date
modified_by: id
2023
aliases
_id: id
alias_type: text
alias: text
assigned_value: text
2028
user_roles
_id: id
name: string
type: string
2036
master_product
product_type: text
product: text
manufacturer: text
classifications:
[classification1, calssification2, . . . ]
features:
[feature1, feature2, . . . ]
options:
[option1, option2, . . . ]
finishes:
[finish1, finish2, . . . ]
2042
[manufacturer_id]_assigned_users
_id:id
user_id: id
user_role_id: id
user_status: text
created_on: date
created_by: id
modified_on: date
modified_by: id
2062
[company_id]_assigned_users
_id: id
user_id: id
user_role_id: id
user_status: text
assigned_projects/project_id
created_on: date
created_by: id
modified_on: date
modified_by: id
[company_id]_classifications
_id: id
name: text
release: date
created_on: date
created_by: id
modified_on: date
modified_by: id
[company_id]_offices
_id: id
name: text
is_billing: boolean
address_line_1: text
address_line_2: text
city: text
state_province: text
postal_code: text
country: text
coordinates: geo_point
created_on: date
created_by: id
modified_on: date
modified_by: id
[manufacturer_id]_offices
_id: id
name: text
is_billing: boolean
address_line_1: text
address_line_2: text
city: text
state_province: text
postal_code: text
country: text
coordinates: geo_point
created_on: date
created_by: id
modified_on: date
modified_by: id
2086
[company_id]_customer_clients
_id: id
customer_client_name: text
created_on: date
created_by: id
modified_on: date
modified_by: id
[company_id]_classification_values
_id: id
classification_id: id
number: text
description: text
created_on: date
created_by: id
modified_on: date
modified_by: id
2064
[company_id]_projects
_id: id
customer_client_name: text
name: text
number: text
description: text
status: short
omniclass_description_1: text
omniclass_description_2: text
omniclass_description_3: text
omniclass_description_4: text
omniclass_number_1: text
omniclass_number_2: text
omniclass_number_3: text
omniclass_number_4: text
status_modified_on: date
status_modified_by: id
office_id: text
address_line_1: text
address_line_2: text
city: text
state_province: text
postal_code: text
country: text
coordinates: geo_point
created_on: date
created_by: text
modified_on: date
modified_by: text
[company_id] measures
_id: id
spec_id: text
description: text
value: decimal
created_on: date
created_by: id
modified_on: date
modified_by: id
2068
[company_id]_project_spec_books
_id: id
project_id: text
name: text
style_id: id
created_on: date
created_by: id
modified_on: date
modified_by: id
2070
[company_id]_working_spec_sections
_id: id
company_id: text
file_name: text
is_master: boolean
latest_draft_version: int
latest_published_version: int
master_published_spec_section: text
spec_section_number: text
spec_section_title: text
master_spec_book_id: int
project_spec_book_id: int
project_id: int
user_id_with_checkout: id
numbering/level_text: text
numbering/numbering_format: text
numbering/outline_level: text
style/font/name: text
style/font/size: long
created_on: date
created_by: id
modified_on: date
modified_by: text
2076
[company_id]_working_specs
_id: id
spec_section_id: text
spec_section_number: text
spec_section_title: text
content: text
product_type: text [standard]
design_preference: text [standard]
manufacturer: text [standard]
product: text [standard]
outline_level: text
vertical_order: long
spec_type: text
is_master: boolean
item_type: text
numbering/level_text: text
numbering/numbering_format: text
numbering/outline_level: text
style/font/color: text
style/font/name: text
style/font/size: long
created_on: date
created_by: text
modified_on: date
modified_by: text
project_id: int
project_spec_book_id: id
master_spec_book_id: id
parent_spec: id
ms_parent_spec: id
2072
[company_id]_draft_spec_sections
_id: id
company_id: text
file_name: text
is_master: boolean
master_published_spec_section: text
draft_version: long
spec_section_number: text
spec_section_title: text
master_spec_book_id: int
project_spec_book_id: int
working_spec_section_id: id
project_id: int
numbering/level_text: text
numbering/numbering_format: text
numbering/outline_level: text
style/font/name: text
style/font/size: long
created_on: date
created_by: id
modified_on: date
modified_by: text
2078
[company_id]_draft_specs
_id: id
spec_section_id: text
spec_section_number: text
spec_section_title: text
draft_version: long
content: text
product_type: text [standard]
design_preference: text [standard]
manufacturer: text [standard]
product: text [standard]
outline_level: text
vertical_order: long
spec_type: text
is_master: boolean
item_type: text
numbering/level_text: text
numbering/numbering_format: text
numbering/outline_level: text
style/font/color: text
style/font/name: text
style/font/size: long
created_on: date
created_by: text
modified_on: date
modified_by: text
project_id: int
project_spec_book_id: id
master_spec_book_id: id
parent_spec: id
ms_parent_spec: id
2066
[company_id]_master_spec_books
_id: id
name: text
description: text
created_on: date
created_by: text
modified_on: date
modified_by: text
2074
[company_id]_spec_sections
_id: id
company_id: text
file_name: text
is_master: boolean
master_published_spec_section: text
published_version: long
spec_section_number: text
spec_section_title: text
master_spec_book_id: int
project_spec_book_id: int
working_spec_section_id: id
project_id: int
numbering/level_text: text
numbering/numbering_format: text
numbering/outline_level: text
style/font/name: text
style/font/size: long
created_on: date
created_by: id
modified_on: date
modified_by: text
2080
[company_id]_specs
_id: id
spec_section_id: text
spec_section_number: text
spec_section_title: text
publish_version: long
content: text
product_type: text [standard]
design_preference: text [standard]
manufacturer: text [standard]
product: text [standard]
outline_level: text
vertical_order: long
spec_type: text
is_master: boolean
item_type: text
numbering/level_text: text
numbering/numbering_format: text
numbering/outline_level: text
style/font/color: text
style/font/name: text
style/font/size: long
created_on: date
created_by: text
modified_on: date
modified_by: text
project_id: int
project_spec_book_id: id
master_spec_book_id: id
parent_spec: id
ms_parent_spec: id
2084
[company_id]_styles
_id: id
style/font/color: text
style/font/name: text
style/font/size: long
numbering/outline_level: text
numbering/level text: text
numbering/number format: text
+ PageTopMargin:double
+ PageBottomMargin:double
+ PageLeftMargin:dobule
+ PageRightMargin:double
+ TitleFont:string
+ TitleFontStyle:string
+ TitleFontSize:double
+ SubTitleFont:string
+ SubTitleFontStyle:string
+ SubTitleFontSize:double
+ SectionHeaderFont:string
+ SectionHeaderFontStyle:string
+ SectionHeaderFontSize:double
created_on: date
created_by: id
modified_on: date
modified_by: id
2082
[company_id]_dashboard
_id
spec_id: text
spec_section_id
spec_section_number: text
spec_type: text
content: text
product_type: text [standard]
design_preference: text [standard]
manufacturer: text [standard]
product: text [standard]
vertical_order: long
assigned_manufacturer: text
assigned_product: text
assigned_prodcut type: text
project_id: text
name: text
status: short
customer_client_name: text
description: text
industry: text
number: text
type: text
address: text
city: text
state_province: text
postal_code: text
country: text
coordinates: geo_point
[company_id] comments
_id: id
specification_id: id
value: text
comment_status: text
thread: int
created_on: date
created_by: id
modified_on: date
modified_by: id

1. A method of creating a project specification book (PSB) via a computer network, the method comprising:
receiving a PSB creation input at a first computer system, the PSB creation input having been transmitted via the computer network from a second computer system, the PSB creation input comprising a request to begin PSB creation;
based upon the PSB creation input, transmitting via the computer network from the first computer system to the second computer system, a PSB creation output, the PSB creation output configured for causing a project information entry to be displayed by the second computer system, wherein
providing the project information entry includes causing a webpage having project information entries to be displayed via a display of the second computer system, the webpage being associated with a website of a service provider;
receiving a project information input at the first computer system, the project information input having been transmitted via the computer network from the second computer system, the project information input comprising project information;
processing the project information input by the first computer system, the processing comprising creating a project text file in a project index of a service provider database, where the first computer system assigns properties of the project index and the information of the project information input to the text file of the project index;
based upon the processing, transmitting via the computer network from the first computer system to the second computer system a project page output for causing project information to be displayed by the second computer system, wherein
providing the project information includes causing a webpage having project information to be displayed via the display of the second computer system, the webpage being associated with the website of the service provider;
receiving a project page input at the first computer system from the second computer system transmitted via the network, the project page input comprising a selected PSB and a selected PSB style;
processing the project page input by the first computer system, the processing comprising creating a text file in a PSB index of the service provider database, where the first computer system assigns properties of the PSB index and the information of the project page input to the text file of the PSB index;
based upon the processing, transmitting via the computer network from the first computer system to the second computer system a PSB page output for causing PSB information to be displayed by the second computer system, wherein
providing the PSB information includes causing a webpage having PSB information to be displayed via a display of the second computer system, the webpage being associated with a website of the service provider;
receiving an add/remove specification section input at the first computer system from the second computer system transmitted via the network, the add/remove specification section input comprising a request for the first computer system to lookup via inverted index search master specification books of a master specification book (MSB) index of the service provider database having a company id associated with a user of the second computer system;
based upon the add/remove specification section input, transmitting via the computer network from the first computer system to the second computer system an MSB output for causing an MSB selection to be displayed by the second computer system, wherein
providing the MSB selection includes causing a webpage having MSB names of the looked up master specification books to be displayed via a display of the second computer system, the webpage being associated with a website of the service provider;
receiving an MSB selection input at the first computer system from the second computer system transmitted via the network, the MSB selection input comprising a selected MSB name and configured for causing the first computer system to search via inverted index search of a published specification index of the service provider database for specification section text files having an MSB id that is associated with the selected MSB name;
based upon the processing of the MSB selection input, transmitting via the computer network from the first computer system to the second computer system a specification sections output for causing specification section numbers of the specifications section text files from the looked up specification section text files to be displayed by the second computer system, wherein
providing the specification sections includes causing a webpage having specification section numbers to be displayed via a display of the second computer system, the webpage being associated with a website of the service provider;
receiving a populate PSB input at the first computer system from the second computer system transmitted via the network, the populate PSB selection input comprising selected specification section numbers and configured for causing the first computer system to process the selected specification sections, wherein the processing includes
copying text files of the selected specification sections from a published specification section index of the service provider database having the MSB id and a published specification section id of the selected specification sections to a working specification sections index of the service provider database and assigning the working specification sections index properties; and
copying text files of specifications associated with the selected specification sections from a published specification index having the published specification section id to a working specifications index of the service provider database and assigning the working specification index properties;
based upon the processing of the populate PSB selection input, transmitting via the computer network from the first computer system to the second computer system a working specification sections output for causing an array of the specification sections of the to be displayed by the second computer system, wherein
providing the specification sections array includes causing a webpage having specification section numbers, description, modification date, and user to be displayed via a display of the second computer system, the webpage being associated with a website of the service provider;
receiving a specification section edit request input at the first computer system from the second computer system transmitted via the network, the specification section edit request input comprising a selected specification section and configured for causing the first computer system to process the selected specification section for editing, wherein the processing includes
identifying specifications associated with the selected specification section via inverted index search using the specification section id of the specification text files of the working specification index;
based upon the processing of the specification section edit request, transmitting via the computer network from the first computer system to the second computer system a specification section edit output for causing the specifications of the selected specification section to be displayed by the second computer system, wherein
providing the specifications includes causing a webpage having the specification sections to be displayed via a display of the second computer system, the webpage being associated with a website of the service provider;
receiving a specification edit input at the first computer system from the second computer system transmitted via the network, the specification section edit input comprising edits to the specifications and configured for causing the first computer system to process the specification edits, wherein the processing includes saving the specification edits in the working specifications index;
based upon the processing of the specification section edit input, receiving a publish request input at the first computer system from the second computer system transmitted via the network, the publish request input configured for causing the first computer system to copy all edited text files from the working specification sections index and working specifications index as text files to the published specification sections index and published specifications index and assigning the associated properties to each newly copied text file of the published specifications section and the published specifications to create the PSB.

2. The method of claim 1, wherein the publish request input is further configured for causing the first computer system to export the edited text files of the published specifications index and published specification sections index to a word processing program to form a complete PSB.

3. The method of claim 1, wherein the publish request input is further configured for causing the edited text files of the published specification section index to be copied to a reporting index of the service provider database.

4. The method of claiml, wherein the project index of the service provider database is associated with a designer; wherein the PSB index of the service provider database is associated with the designer; wherein the MSB index of the service provider database is associated with the designer; wherein the published specification index of the service provider database is associated with the designer; wherein the published specification section index of the service provider database is associated with the designer; wherein the working specifications section index of the service provider database is associated with the designer; wherein the working specification index of the service provide database is associated with the designer; wherein the published specification index of the service provider database is associated with the designer.

5. The method of claim 5, wherein the publish request input is further configured for causing the edited text files of the published specification section index to be copied to a reporting index of the service provider databased that is associated with the designer.

6. The method of claim 1, wherein the project index of the service provider database is a consolidated project index; wherein the PSB index of the service provider database is a consolidated PSB index; wherein the MSB index of the service provider database is a consolidated MSB index; wherein the published specification index of the service provider database is a consolidated published specification index; wherein the working specifications section index of the service provider database is a consolidated working specifications section index; wherein the working specification index of the service provider database is a consolidated working specification index; wherein the published specification index of the service provider database is a consolidated published specification index.

7. The method of claim 7, wherein the publish request input is further configured for causing the edited text files of the published specification section index to be copied to a reporting index of the service provider database that is a consolidated reporting index.

8. A method of determining product use in a geographic area via a computer network, the method comprising:
receiving a product search initiation input at a first computer system, the product search initiation input having been transmitted via the computer network from a third computer system being associated with a manufacturer, the product search initiation input comprising a request to begin a product search;
based upon the product search initiation input, transmitting via the computer network from the first computer system to the second computer system a product search output for causing a product search entry to be displayed by the second computer system, wherein
providing the product search entry causing a webpage having the product search entries of a product name and a product geography to be displayed via a display of the second computer system, the webpage being associated with a website of a service provider;
based upon the product search entry, receiving a product search input at a first computer system, the product search input having been transmitted via the computer network from a third computer system, the product search input comprising information entered for a product and a geography of interest and configured for causing the first computer system to process the product search input;
processing the product search input by the first computer system, the processing comprising searching a reporting index of a service provider database via inverted index search to identify text files having the product and geography properties equal to the product search input and the manufacturer's name;
transmitting via the computer network from the first computer system to the third computer system a product results output for causing product use information in the geography to be displayed by the third computer system, wherein
providing the product results causing a webpage having the product search results to be displayed via a display of the second computer system, the webpage being associated with a web site of the service provider.

9. A method of determining standard use in a geographic area via a computer network, the method comprising:
receiving a standard search initiation input at a first computer system, the standard search initiation input having been transmitted via the computer network from a third computer system being associated with a manufacturer, the standard search initiation input comprising a request to begin a standard search;
based upon the standard search initiation input, transmitting via the computer network from the first computer system to the second computer system a standard search output for causing a standard search entry to be displayed by the second computer system, wherein
providing the standard search entry causing a webpage having the standard search entries of a standard name and a geography to be displayed via a display of the second computer system, the webpage being associated with a website of the service provider;
based upon the standard search entry, receiving a standard search input at a first computer system, the standard search input having been transmitted via the computer network from a third computer system, the standard search input comprising information entered for a standard and a geography of interest and configured for causing the first computer system to process the standard search input;
processing the standard search input by the first computer system, the processing comprising searching a reporting index of a service provider database via inverted index search to identify text files having the standard and geography properties equal to the standard search input;
transmitting via the computer network from the first computer system to the third computer system a standard results output for causing standard use information in the geography to be displayed by the third computer system, wherein
providing the standard results causing a webpage having the standard search results to be displayed via a display of the second computer system, the webpage being associated with a web site of the service provider.

10. A method for identifying changes to a project specification section via a computer network, the method comprising:
receiving a comparison input at a first computer system, the comparison input having been transmitted via the computer network from a second computer system, the comparison input comprising a request to process a comparison of a preselected project specification section to an associated master specification section, the first computer system being associated with a service provider, the second computer system being associated with a designer;
based upon the comparison input, processing the comparison of the preselected project specification section to the associated master specification section, the comparison being processed by the first computer system, where the processing comprises
the first computer system searching a published specifications index of a service provider database to identify published specification ids of a published specification index that match ms parent spec ids of specifications of the preselected specification section; and
upon identification of matching published specification ids and ms parent spec ids comparing the content of the text files associated with the ms parent spec ids and published specification ids to generate a comparison of the preselected specification index to the published specification section;
transmitting a comparison output from the first computer system to the second computer system via the computer network, the comparison output configured for the comparison of the preselected specification index to the published specification section to be provided to the second computer system, wherein
providing the comparison includes causing the webpage having the comparison to be displayed via the display of the second computer system.

11. The method of claim 10, wherein the request of the comparison input further comprises a comparison of a second preselected project specification section to the associated master specification section; and wherein the processing further comprises
the first computer system searching the published specifications index to identify published specification ids of the published specification index that mat ms parent spec ides of sections of the second preselected specification section; and upon identification of matching published specification ids and ms parent spec ids comparing the content of the text files associated with the ms parent spec ids and published specification ids to to produce a comparison of the second preselected specification index to the published specification section; and
wherein the processing further comprises comparing the comparison of the preselected specification index to the published specification section to the second preselected specification index to the published specification section to produce a comparison of the preselected specification section to the second preselected specification section; and
wherein the comparison output is configured for the comparison of the preselected specification section to the second preselected specification section to be provided to the second computer system.
